(19) United States
(12) Patent Application Publication
(10) Pub. No.: US 2026/0099200 A1
(43) Pub. Date: Apr. 9, 2026

(54) ELECTRONIC APPARATUS AND CONTROLLING METHOD THEREOF

(71) Applicant: SAMSUNG ELECTRONICS CO., LTD., Suwon-si (KR)

(72) Inventors: Dongho LEE, Suwon-si (KR); Shina Kim, Suwon-si (KR); Soyon You, Suwon-si (KR); Jihae Lim, Suwon-si (KR); Jongpil Kim, Suwon-si (KR); Hyuntae Kim, Suwon-si (KR)

(73) Assignee: SAMSUNG ELECTRONICS CO., LTD., Suwon-si (KR)

(21) Appl. No.: 19/410,396

(22) Filed: Dec. 5, 2025

Related U.S. Application Data
(63) Continuation of application No. PCT/KR2025/010472, filed on Jul. 16, 2025.

(30) Foreign Application Priority Data
Oct. 7, 2024 (KR) 10-2024-0135885

(51) Int. Cl. G06F 3/01; G06F 3/04815; G06F 3/0488; G06F 3/14; G06F 3/16

(52) U.S. Cl. CPC G06F 3/012; G06F 3/017; G06F 3/04815; G06F 3/0488; G06F 3/1407; G06F 3/167

(57) ABSTRACT

An electronic apparatus includes memory storing instructions; a display; a camera; and at least one processor, wherein the instructions, when executed, cause the electronic apparatus to play content stored in the memory and display the content being played on the display; obtain a first captured image from the camera; obtain first rotation angle information of a head object based on the first captured image; stop the content being played based on the first rotation angle information indicating a first event in which the head object rotates outside a threshold range; obtain a second captured image from the camera after the content is stopped; obtain second rotation angle information of the head object based on the second captured image; and play the content that is stopped based on the second rotation angle information indicating a second event in which the head object rotates within the threshold range.

### CROSS-REFERENCE TO RELATED APPLICATION

This application is a bypass continuation of International Application No. PCT/KR2025/010472, filed on Jul. 16, 2025, which is based on and claims priority to Korean Patent Application No. 10-2024-0135885, filed on Oct. 7, 2024, in the Korean Intellectual Property Office, the disclosures of which are incorporated by reference herein in their entireties.

### BACKGROUND

### 1. Field

The present disclosure relates to an electronic apparatus and a control method thereof, and more particularly, to an electronic apparatus for analyzing a user included in a captured image and performing an operation corresponding to an analysis result, and a control method thereof.

### 2. Description of Related Art

A user may be recognized using a camera. An electronic apparatus may analyze the user included in a captured image. The electronic apparatus may perform various operations based on an analysis result of the user.

If the user inputs a control command by typing, touching, speaking, or the like, it may take a long time or be inconvenient. The electronic apparatus may need to automatically perform a specific operation based only on the analysis result of the recognized user.

If the user inputs a control command by using a remote control device, it may be inconvenient because the user has to find the remote control device directly. The electronic apparatus may need to automatically perform a specific operation without the user using the remote control device.

The electronic apparatus may receive a gesture input (or a motion input) to automatically perform a specific operation. However, it may be inconvenient because the user has to remember the gesture input.

The user may generally input a control command using his or her hands. However, in a specific situation where the user is unable to use his or her hands (such as holding a specific object in both hands), it may be difficult for the user to use the gesture input.

### SUMMARY

The present disclosure provides an electronic apparatus for analyzing a user included in a captured image and determining whether to provide content based on an analysis result, and a control method thereof.

According to an aspect of the disclosure, an electronic apparatus includes memory storing instructions; a display; a camera; and at least one processor, wherein the instructions, when executed, individually or collectively, by the at least one processor, cause the electronic apparatus to play content stored in the memory and display the content being played on the display; obtain a first captured image from the camera; obtain first rotation angle information of a head object based on the first captured image; stop the content being played based on the first rotation angle information indicating a first event in which the head object rotates outside a threshold range; obtain a second captured image from the camera after the content is stopped; obtain second rotation angle information of the head object based on the second captured image; and play the content that is stopped based on the second rotation angle information indicating a second event in which the head object rotates within the threshold range.

The first rotation angle information may include at least one of a first rotation angle or a first rotation angle change amount, and the second rotation angle information may include at least one of a second rotation angle or a second rotation angle change amount.

The instructions, when executed, individually or collectively, by the at least one processor, may cause the electronic apparatus to identify the head object of a user based on the first captured image; obtain at least one of a pitch rotation angle or a yaw rotation angle of the head object; and obtain the first rotation angle based on the at least one of the pitch rotation angle or the yaw rotation angle.

The instructions, when executed, individually or collectively, by the at least one processor, may cause the electronic apparatus to obtain a first value by multiplying the pitch rotation angle by a first weight; obtain a second value by multiplying the yaw rotation angle by a second weight; and obtain the first rotation angle by adding the first value to the second value.

The first rotation angle change amount may be obtained based on a difference between a rotation angle obtained at a first time point and a rotation angle obtained at a time point previous to the first time point.

The instructions, when executed, individually or collectively, by the at least one processor, may cause the electronic apparatus to identify the first event based on at least one of a first condition or a second condition being satisfied. The first condition may be satisfied based on the first rotation angle being less than or equal to a first threshold value or the first rotation angle being greater than or equal to a second threshold value, and the second condition may be satisfied based on the first rotation angle change amount being less than or equal to a third threshold value or the first rotation angle change amount being greater than or equal to a fourth threshold value.

The instructions, when executed, individually or collectively, by the at least one processor, may cause the electronic apparatus to identify the second event based on at least one of a third condition or a fourth condition being satisfied. The third condition may be satisfied based on the first rotation angle exceeding the first threshold value and the first rotation angle being less than the second threshold value, and the fourth condition may be satisfied based on the first rotation angle change amount exceeding the third threshold value and the first rotation angle change amount being less than the fourth threshold value.

The instructions, when executed, individually or collectively, by the at least one processor, may cause the electronic apparatus to generate a guide user interface (UI) indicating a rotation of the head object based on the first rotation angle; and control the display to display the guide UI at a predetermined position.

The instructions, when executed, individually or collectively, by the at least one processor, may cause the electronic apparatus to identify a first candidate region corresponding to a hand object of a user and a second candidate region corresponding to a foot object of the user in the first captured image; determine a target position based on the first candidate region and the second candidate region; and control the display to display an augmented reality UI at the target position to determine whether to play or stop the content.

The instructions, when executed, individually or collectively, by the at least one processor, may cause the electronic apparatus to obtain a target distance between the electronic apparatus and a user; obtain user height information; obtain a first threshold distance based on the user height information; perform a first mode for receiving a touch input based on the target distance being less than the first threshold distance; perform a second mode for receiving a motion input based on the target distance being greater than or equal to the first threshold distance; and perform a third mode for receiving a voice input if the user is not recognized based on the first captured image.

According to an aspect of the disclosure, a control method of an electronic apparatus includes playing content stored in memory and displaying the content being played; obtaining a first captured image from a camera; obtaining first rotation angle information of a head object based on the first captured image; stopping the content being played based on the first rotation angle information indicating a first event in which the head object rotates outside a threshold range; obtaining a second captured image from the camera after the content is stopped; obtaining second rotation angle information of the head object based on the second captured image; and playing the content that is stopped based on the second rotation angle information indicating a second event in which the head object rotates within the threshold range.

The first rotation angle information may include at least one of a first rotation angle or a first rotation angle change amount, and the second rotation angle information may include at least one of a second rotation angle or a second rotation angle change amount.

The obtaining the first rotation angle information may include identifying the head object of a user based on the first captured image; obtaining at least one of a pitch rotation angle or a yaw rotation angle of the head object; and obtaining the first rotation angle based on the at least one of the pitch rotation angle or the yaw rotation angle.

The obtaining the first rotation angle information may include obtaining a first value by multiplying the pitch rotation angle by a first weight; obtaining a second value by multiplying the yaw rotation angle by a second weight; and obtaining the first rotation angle by adding the first value to the second value.

The first rotation angle change amount may be obtained based on a difference between a rotation angle obtained at a first time point and a rotation angle obtained at a time point previous to the first time point.

The first event may be identified based on at least one of a first condition or a second condition being satisfied. The first condition may be satisfied based on the first rotation angle being less than or equal to a first threshold value or the first rotation angle being greater than or equal to a second threshold value, and the second condition may be satisfied based on the first rotation angle change amount being less than or equal to a third threshold value or the first rotation angle change amount being greater than or equal to a fourth threshold value.

The second event may be identified based on at least one of a third condition or a fourth condition being satisfied. The third condition may be satisfied based on the first rotation angle exceeding the first threshold value and the first rotation angle being less than the second threshold value, and the fourth condition may be satisfied based on the first rotation angle change amount exceeding the third threshold value and the first rotation angle change amount being less than the fourth threshold value.

The method may further include generating a guide user interface (UI) indicating a rotation of the head object based on the first rotation angle; and displaying the guide UI at a predetermined position.

The method may further include identifying a first candidate region corresponding to a hand object of a user and a second candidate region corresponding to a foot object of the user in the first captured image; determining a target position based on the first candidate region and the second candidate region; and displaying an augmented reality UI at the target position to determine whether to play or stop the content.

According to an aspect of the disclosure, a non-transitory computer-readable recording medium having instructions recorded thereon, that, when executed by at least one processor, individually or collectively, cause the at least one processor to play content stored in memory and display the content being played; obtain a first captured image from a camera; obtain first rotation angle information of a head object based on the first captured image; stop the content being played based on the first rotation angle information indicating a first event in which the head object rotates outside a threshold range; obtain a second captured image from the camera after the content is stopped; obtain second rotation angle information of the head object based on the second captured image; and play the content that is stopped based on the second rotation angle information indicating a second event in which the head object rotates within the threshold range.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a diagram for describing an electronic apparatus for recognizing a user according to an embodiment.

FIG. 2 is a block diagram showing the electronic apparatus according to an embodiment.

FIG. 3 is a block diagram for describing a configuration of the electronic apparatus in FIG. 2 according to an embodiment.

FIG. 4 is a diagram for describing an operation for playing or stopping content according to an embodiment.

FIG. 5 is a diagram for describing an operation for obtaining rotation angle information of a head object according to an embodiment.

FIG. 6 is a diagram for describing a reference for a rotation angle reference according to an embodiment.

FIG. 7 is a diagram for describing an operation for stopping content based on the head rotation according to an embodiment.

FIG. 8 is a diagram for describing an operation for stopping content based on the head rotation according to an embodiment.

FIG. 9 is a diagram for describing a guide user interface (UI) indicating the head rotation according to an embodiment.

FIG. 10 is a diagram for describing an operation for calculating a rotation angle of a head according to an embodiment.

FIG. 11 is a diagram for describing a condition corresponding to the head rotation according to an embodiment.

FIG. 12 is a diagram for describing an operation for displaying an augmented reality (AR) UI according to an embodiment.

FIG. 13 is a diagram for describing a guide screen for body analysis according to an embodiment.

FIG. 14 is a diagram for describing operations for displaying the augmented reality UI and identifying a candidate region according to an embodiment.

FIG. 15 is a diagram for describing an operation for identifying a candidate position according to an embodiment.

FIG. 16 is a diagram for describing a target position for displaying the augmented reality UI according to an embodiment.

FIG. 17 is a diagram for describing an operation for changing a target position according to an embodiment.

FIG. 18 is a diagram for describing an operation for determining a size of the augmented reality UI according to an embodiment.

FIG. 19 is a diagram for describing an operation for determining a size of the augmented reality UI based on a distance between the user and the electronic apparatus according to an embodiment.

FIG. 20 is a diagram for describing an operation for determining a size of the augmented reality UI based on user height information according to an embodiment.

FIG. 21 is a diagram for describing an operation for displaying the augmented reality UI at a position based on an event according to an embodiment.

FIG. 22 is a diagram for describing an operation for displaying the augmented reality UI at a position based on an event according to an embodiment.

FIG. 23 is a diagram for describing an operation for displaying the augmented reality UI at a position according to an embodiment.

FIG. 24 is a diagram for describing an operation for playing or stopping content through the augmented reality UI according to an embodiment.

FIG. 25 is a diagram for describing an operation for determining a mode in consideration of a user height and a user position according to an embodiment.

FIG. 26 is a diagram for describing an operation for determining a mode to be executed according to an embodiment.

FIG. 27 is a diagram for describing a condition for performing the mode according to an embodiment.

FIG. 28 is a diagram for describing a touch mode according to an embodiment.

FIG. 29 is a diagram for describing an AR mode according to an embodiment.

FIG. 30 is a diagram for describing a voice recognition mode according to an embodiment.

FIG. 31 is a diagram for describing a screen structure displayed based on a mode according to an embodiment.

FIG. 32 is a diagram for describing an operation for calculating a threshold distance by using the user height information according to an embodiment.

FIG. 33 is a diagram for describing an operation for switching a mode according to an embodiment.

FIG. 34 is a diagram for describing a screen switch operation according to an embodiment.

FIG. 35 is a diagram for describing a screen switch operation according to an embodiment.

FIG. 36 is a diagram for describing a control method of an electronic apparatus according to an embodiment.

### DETAILED DESCRIPTION

The embodiments described in the disclosure, and the configurations shown in the drawings, are only examples of embodiments, and various modifications may be made without departing from the scope of the disclosure.

General terms that are currently widely used are selected as terms used in embodiments of the present disclosure in consideration of their functions in the present disclosure, and such terms may be changed based on the intention of those skilled in the art or a judicial precedent, the emergence of a new technique, or the like. In addition, in some cases, terms arbitrarily chosen by an applicant may exist. In this case, the meanings of such terms may be indicated in the corresponding descriptions of the present disclosure. Therefore, the terms used in the present disclosure are to be defined on the basis of the meanings of the terms and the contents throughout the present disclosure rather than simple names of the terms.

In the present disclosure, an expression “have”, “may have”, “include”, “may include” or the like, indicates existence of a corresponding feature (for example, a numerical value, a function, an operation or a component such as a part), and does not exclude existence of an additional feature.

An expression, “at least one of A or/and B” may indicate either “A or B”, or “both of A and B.”

Expressions “first”, “second” and the like, used in the present disclosure may indicate various components regardless of the sequence or importance of the components. The expression is used only to distinguish one component from another component, and does not limit the corresponding component.

If any component (for example, a first component) is mentioned to be “(operatively or communicatively) coupled with/to” or “connected to” another component (for example, a second component), it should be understood that any component is directly coupled to another component or coupled to another component through still another component (for example, a third component).

A term of a singular number may include its plural number unless explicitly indicated otherwise in the context. It should be understood that a term “include” or “have” used in this application specifies the presence of features, numerals, steps, operations, components, parts, or combinations thereof, which are mentioned in the specification, and does not preclude the presence or addition of one or more other features, numerals, steps, operations, components, parts, or combinations thereof.

In the present disclosure, a “module” or a “˜er/˜or” may perform at least one function or operation, and be implemented by hardware, software, or a combination of hardware and software. In addition, a plurality of “modules” or a plurality of “˜ers/˜ors” may be integrated in at least one module and be implemented by at least one processor except for a “module” or a “˜er/or”that may be implemented in hardware.

The term “user” may refer to a person using an electronic apparatus or a device using the electronic apparatus (e.g., artificial intelligence electronic apparatus).

Hereinafter, the embodiments of the present disclosure are described in detail with reference to the accompanying drawings.

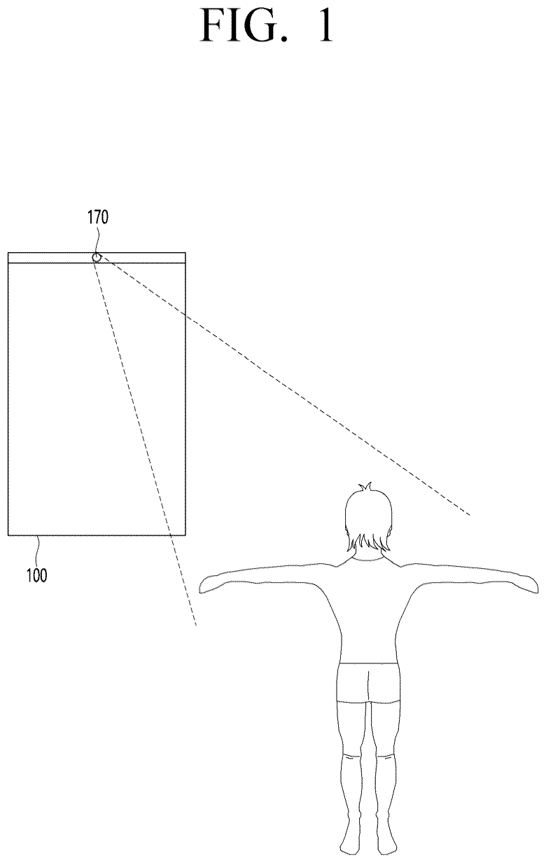

FIG. 1 is a diagram for describing an electronic apparatus 100 for recognizing a user according to an embodiment.

Referring to FIG. 1, the electronic apparatus 100 may include a camera 170. The electronic apparatus 100 may obtain a captured image from the camera 170. The electronic apparatus 100 may obtain the captured image including a user. The electronic apparatus 100 may recognize the user and perform various functions.

For example, the electronic apparatus 100 may perform a function for playing or stopping content based on an angle of the head rotation of the user.

For example, the electronic apparatus 100 may recognize the user and provide augmented reality (AR) content.

For example, the electronic apparatus 100 may perform a mode based on a result of recognizing the user.

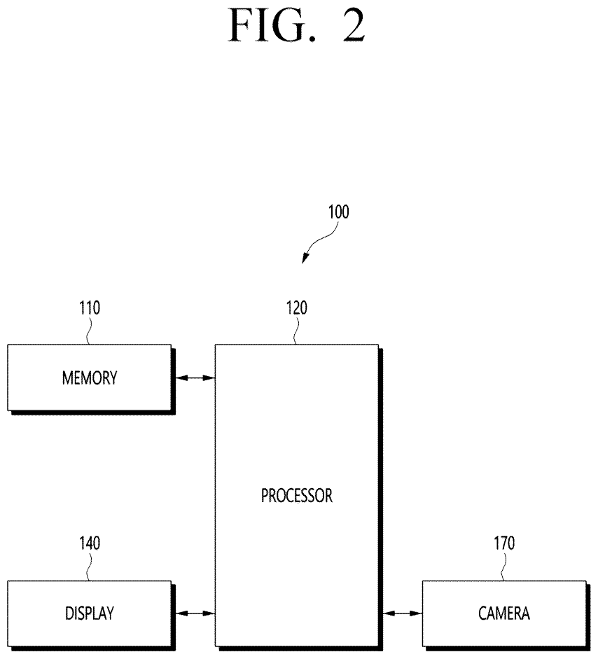

FIG. 2 is a block diagram showing the electronic apparatus 100 according to an embodiment.

Referring to FIG. 2, the electronic apparatus 100 may include at least one of memory 110, a display 140, or at least one processor 120.

The electronic apparatus 100 may include the memory 110 storing instructions, the display 140, the camera 170, and at least one processor 120 including processing circuitry.

At least one processor 120 may play content stored in the memory 110 and display the content being played on the display 140. At least one processor 120 may play content selected by the user from the plurality of content stored in the memory 110. For example, the content may be received from a content providing device. The content may include data received from the content providing device in real time. The content may be displayed through real-time streaming.

At least one processor 120 may obtain a first captured image from the camera 170 while playing the content. At least one processor 120 may obtain first rotation angle information of a head object based on the first captured image. At least one processor 120 may stop the content being played based on the first rotation angle information indicating a first event in which the head object rotates outside a threshold range.

At least one processor 120 may obtain a second captured image from the camera 170 after the content is stopped. At least one processor 120 may obtain second rotation angle information of the head object based on the second captured image. At least one processor 120 may play the content that is stopped based on the second rotation angle information indicating a second event in which the head object rotates within the threshold range.

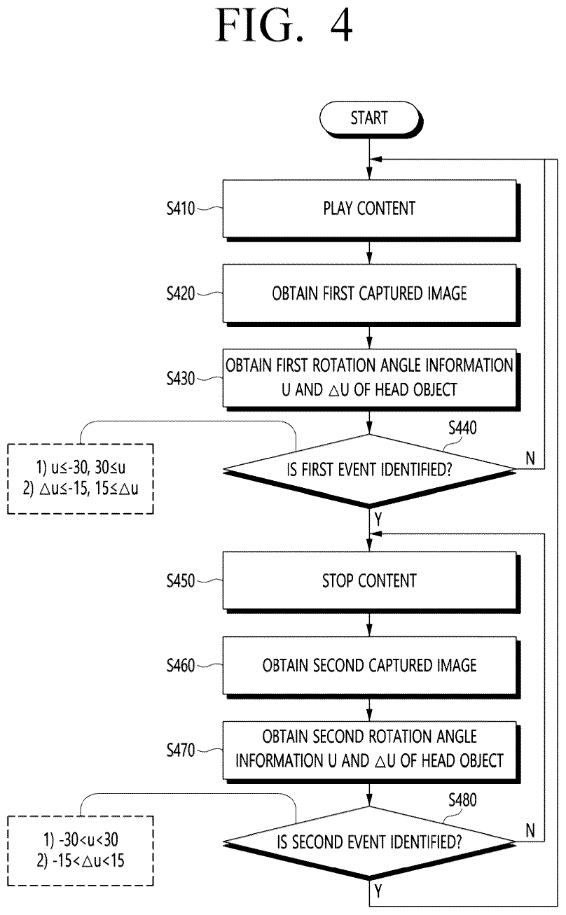

An operation related to playing or stopping the content is described with reference to FIG. 4.

At least one processor 120 may analyze the user based on the first captured image and the second captured image. At least one processor 120 may identify the head object of the user included in the first captured image and the second captured image. At least one processor 120 may obtain various information related to the rotation of the head object.

The first rotation angle information may include at least one of a first rotation angle or a first rotation angle change amount. The second rotation angle information may include at least one of a second rotation angle or a second rotation angle change amount.

The rotation angle may include information indicating a degree of rotation of the head object. The rotation angle information may include information indicating the degree of the head rotation of the user with respect to a reference axis (e.g., a roll axis, a pitch axis, or a yaw axis). The rotation angle may be described as the degree of rotation, rotation data, a head posture angle, or the like.

The rotation angle change amount may include information indicating a difference between a rotation angle at a current time point and a rotation angle at a previous time point. A difference between the current time point and the previous time point may be classified into a unit time. The unit time may be changed based on a user setting. For example, the unit time may be one second. The rotation angle change amount may be described as a rotation change amount, rotation change amount data, a head posture change amount, or the like.

The rotation angle information may be described as a rotation angle set, rotation information, the rotation data, head posture information, a rotation data group, or the like.

At least one processor 120 may identify the head object of the user based on the first captured image. At least one processor 120 may obtain at least one of the pitch rotation angle or yaw rotation angle of the head object. At least one processor 120 may not use a roll rotation angle. The reason is that the roll rotation of the head object may be a habitual behavior of the user. At least one processor 120 may determine whether to play the content based on the degree of the head rotation of the user. At least one processor 120 may determine whether to play the content by using at least one of the pitch rotation angle or the yaw rotation angle.

At least one processor 120 may obtain the first rotation angle based on at least one of the pitch rotation angle or the yaw rotation angle.

For example, at least one processor 120 may obtain the first rotation angle based on the pitch rotation angle or the yaw rotation angle.

For example, at least one processor 120 may obtain the first rotation angle based on the pitch rotation angle.

For example, at least one processor 120 may obtain the first rotation angle based on the yaw rotation angle.

At least one processor 120 may obtain a first value by multiplying the pitch rotation angle by a first weight. At least one processor 120 may obtain a second value by multiplying the yaw rotation angle by a second weight. At least one processor 120 may obtain the first rotation angle by adding the first value to the second value.

At least one processor 120 may obtain the first rotation angle change amount based on a difference between a rotation angle obtained at a first time point and a rotation angle obtained at a time point previous to the first time point. At least one processor 120 may obtain the first rotation angle information including at least one of the first rotation angle or the first rotation angle change amount.

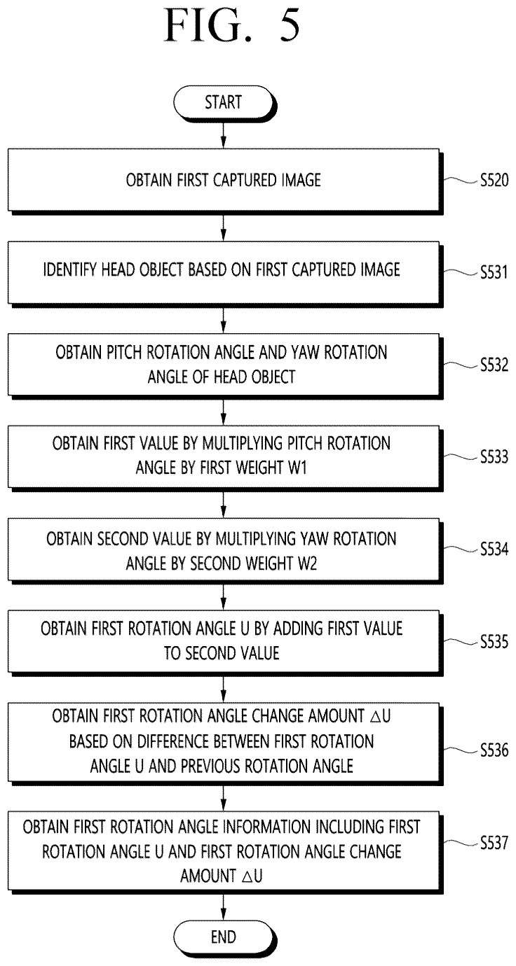

An operation for obtaining the first rotation angle or the first rotation angle change amount is described with reference to FIG. 5. A step for obtaining the first rotation angle or the first rotation angle change amount described above may be equally applied to a step for obtaining the second rotation angle or the second rotation angle change amount.

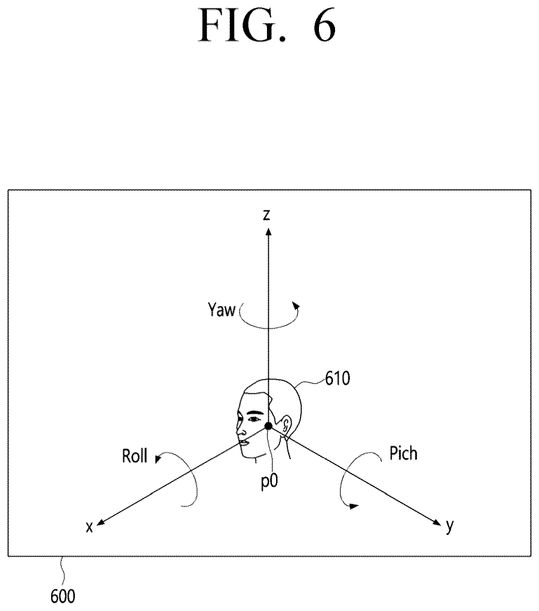

A description of the reference axis indicating the rotation angle is provided with reference to FIG. 6.

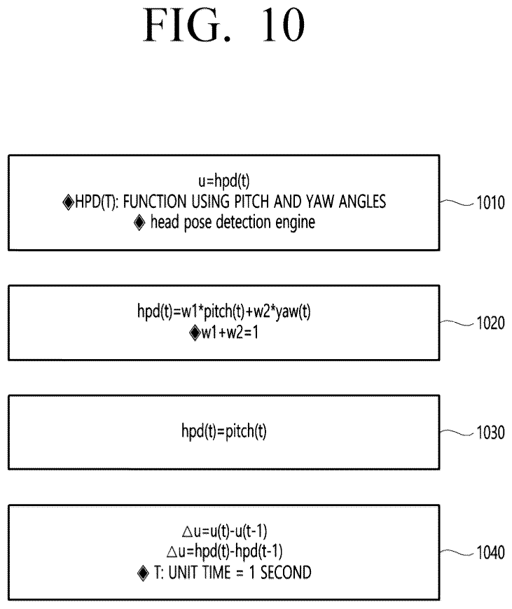

Equations for calculating the first rotation angle and the first rotation angle change amount are described with reference to FIG. 10.

At least one processor 120 may identify that the first event based on at least one of a first condition or a second condition being satisfied. The first condition may be satisfied based on the first rotation angle being less than or equal to a first threshold value or the first rotation angle being greater than or equal to a second threshold value, and the second condition may be satisfied based on the first rotation angle change amount being less than or equal to a third threshold value or the first rotation angle change amount being greater than or equal to a fourth threshold value.

At least one processor 120 may identify the second event based on at least one of a third condition or a fourth condition being satisfied. The third condition may be satisfied based on the first rotation angle exceeding the first threshold value and the first rotation angle being less than the second threshold value. The fourth condition may be satisfied based on the first rotation angle change amount exceeding the third threshold value and the first rotation angle change amount being less than the fourth threshold value, is satisfied.

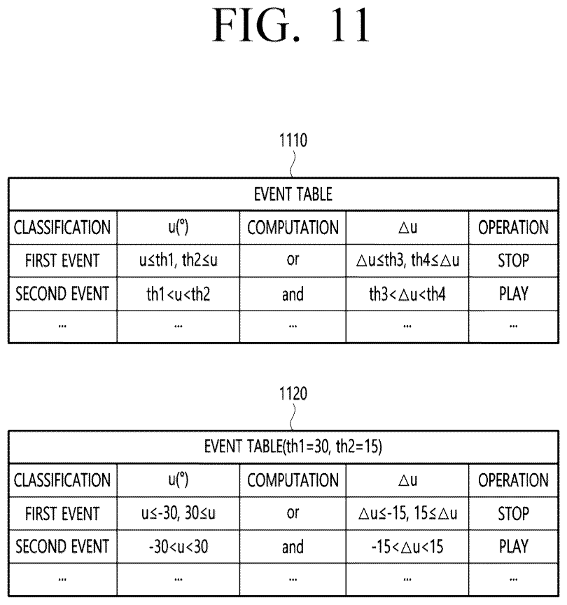

Various conditions related to the first rotation angle and the first rotation angle change amount are described with reference to FIG. 11.

At least one processor 120 may generate a guide user interface (UI) indicating the rotation of the head object based on the first rotation angle. At least one processor 120 may control the display 140 to display the guide UI at a predetermined position.

The guide UI may be a UI for indicating the head rotation of the user in real time. The guide UI may include an icon indicating a direction of the head rotation of the user. Through the guide UI, the user may recognize the direction of the head rotation recognized by the electronic apparatus 100 in real time.

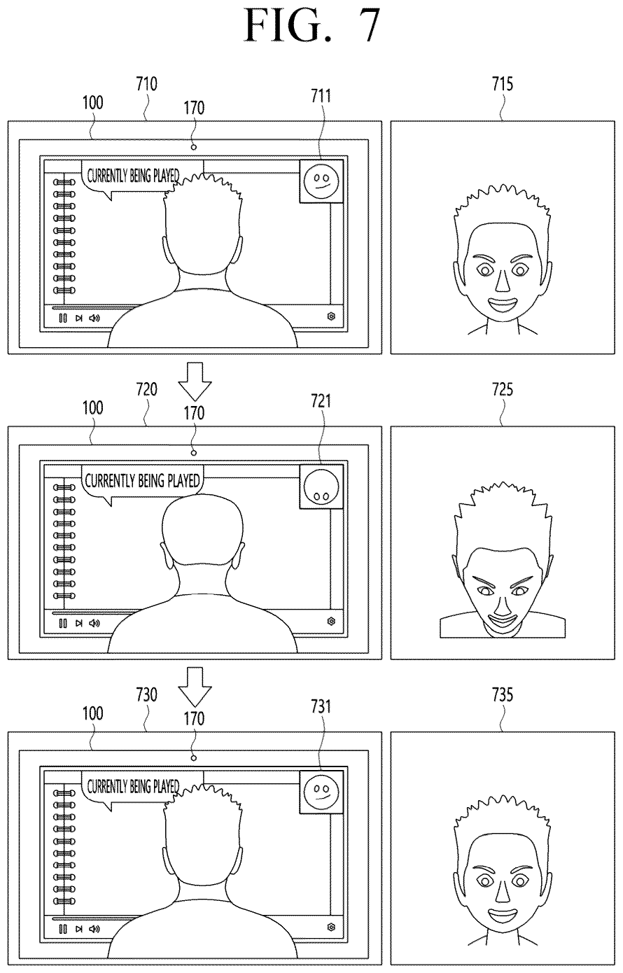

A description related to the guide UI is described with reference to FIGS. 7 to 9.

At least one processor 120 may provide an augmented reality (AR) service. At least one processor 120 may display an augmented reality UI on a screen related to the content. The augmented reality UI may be displayed in a pop-up form on the currently displayed screen. At least one processor 120 may determine a target position for displaying the augmented reality UI. The augmented reality UI may be a virtual UI included in the screen on which the actually captured image is displayed upon providing the AR service. The user may only check the augmented reality UI through the display 140.

At least one processor 120 may identify a first candidate region corresponding to a hand object of the user and a second candidate region corresponding to a foot object of the user in the first captured image. At least one processor 120 may determine the target position based on the first candidate region and the second candidate region. At least one processor 120 may control the display 140 to display the augmented reality UI at the target position to determine whether to play or stop the content.

At least one processor 120 may receive a user motion input through the augmented reality UI.

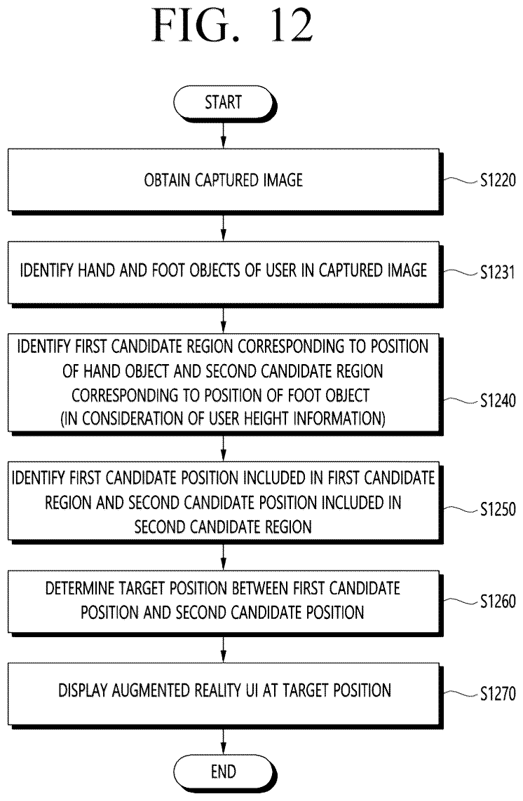

A description related to the augmented reality UI is provided with reference to FIGS. 12 to 24.

An operation for determining the target position for displaying the augmented reality UI is described with reference to FIG. 12.

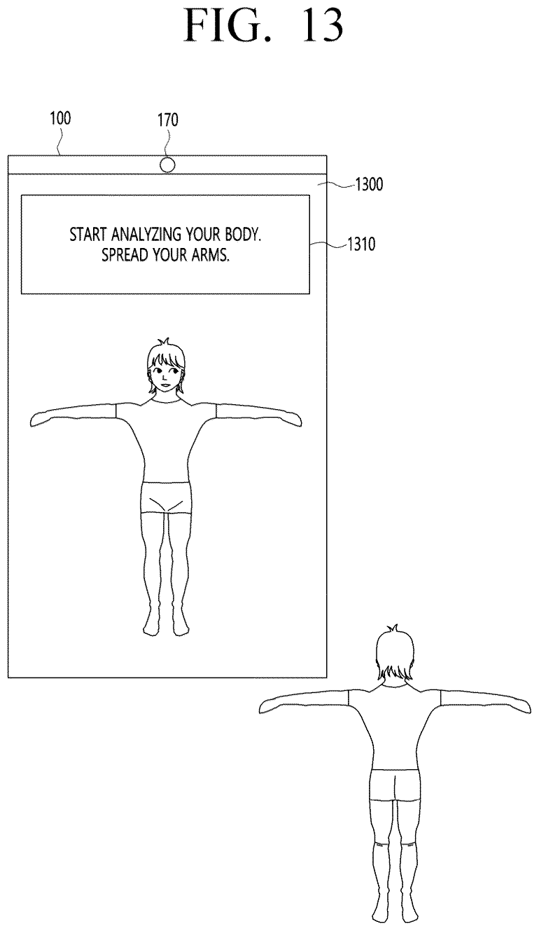

An operation for displaying a guide screen for body analysis of the user is described with reference to FIG. 13.

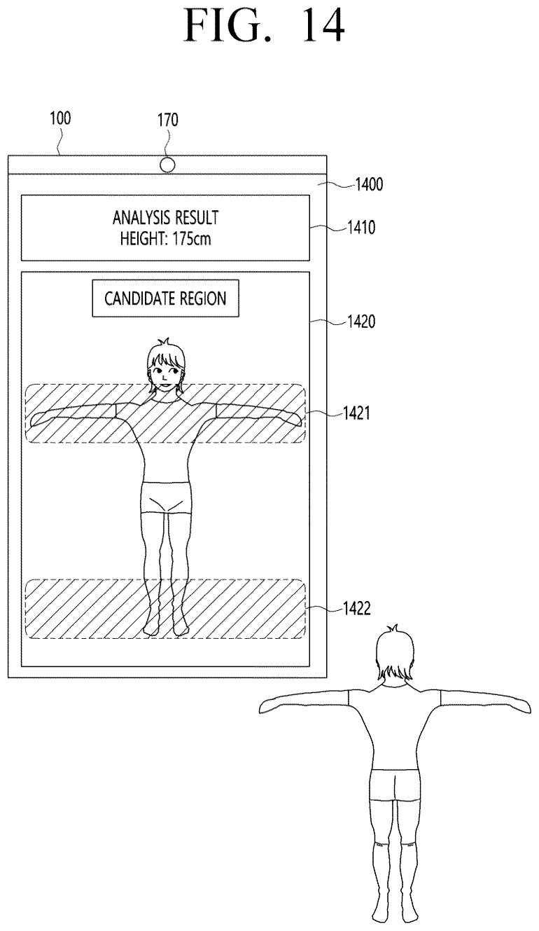

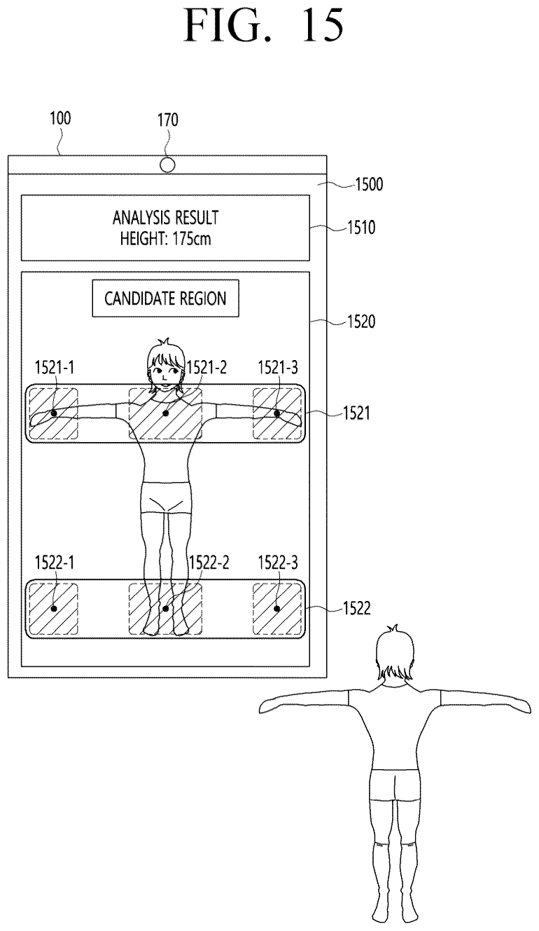

The candidate region and the candidate position for determining the target position are described with reference to FIGS. 14 and 15.

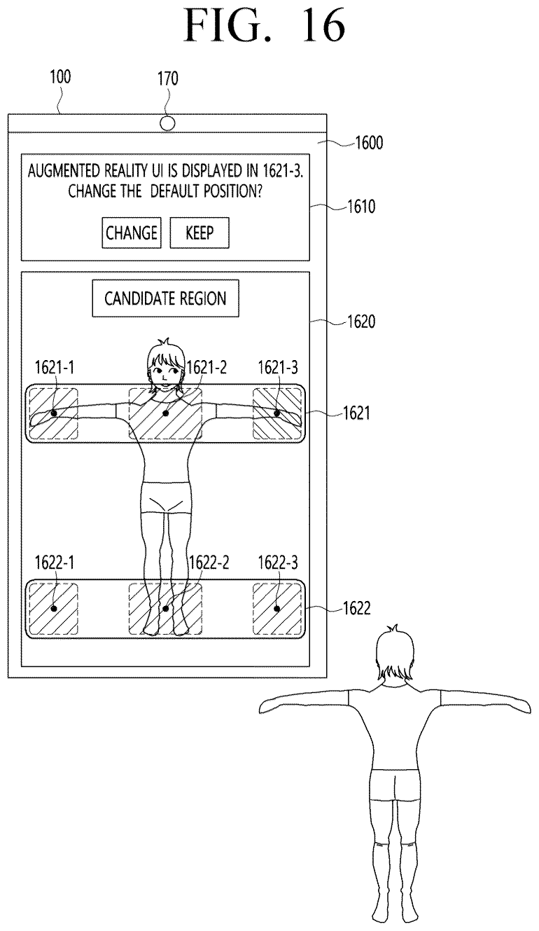

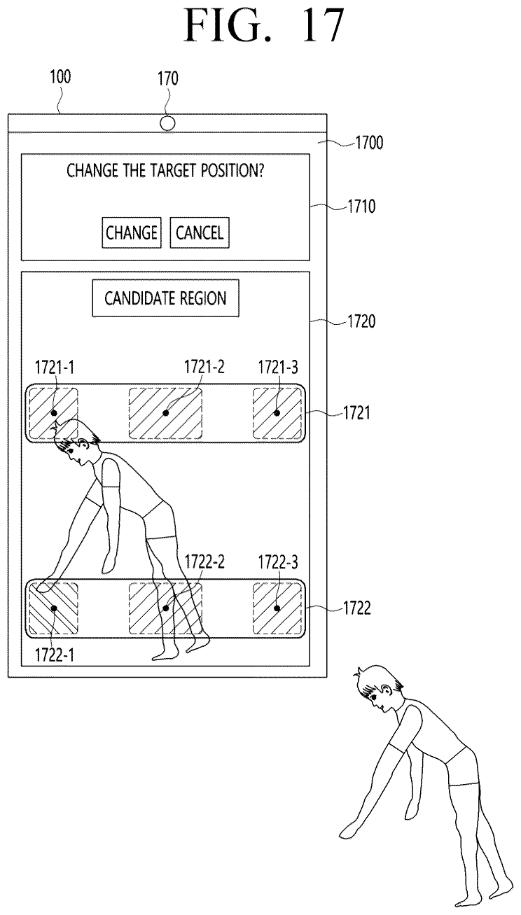

Operations for confirming and changing the target position are described with reference to FIGS. 16 and 17.

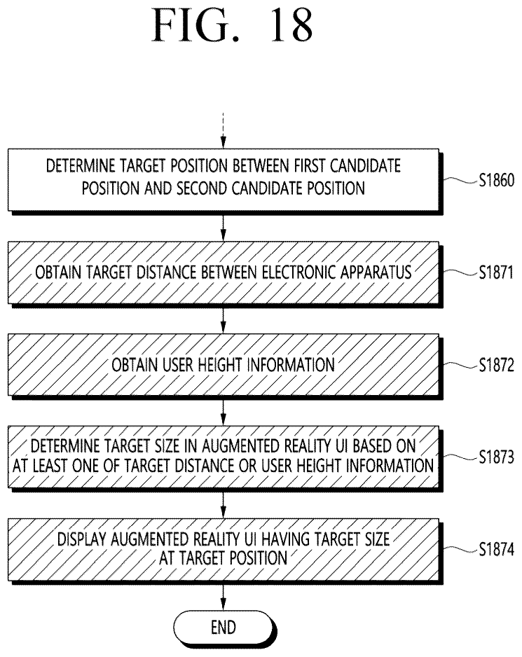

An operation for determining a target size by using a target distance and user height information is described with reference to FIGS. 18 to 20. The target distance may indicate a distance between the electronic apparatus 100 and the user. The target size may indicate a size for displaying the augmented reality UI.

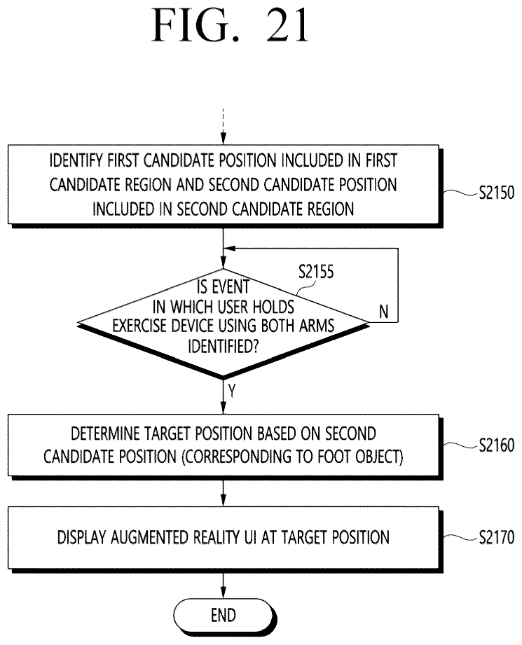

An operation for displaying the augmented reality UI at a position in a situation where the user is holding exercise equipment using both arms is described with reference to FIGS. 21 to 24.

At least one processor 120 may provide various modes based on the target distance. The various modes may include at least one of a first mode, a second mode, or a third mode.

The first mode may be a mode for receiving a user touch input. The first mode may be referred to as a touch mode.

The second mode may be a mode for receiving the user motion input. The second mode may be referred to as an AR mode.

The third mode may be a mode for receiving a user voice input. The third mode may be referred to as a voice recognition mode.

At least one processor 120 may obtain the target distance between the electronic apparatus 100 and the user. At least one processor 120 may obtain the user height information. At least one processor 120 may obtain a first threshold distance based on the user height information.

For example, the electronic apparatus 100 may determine a first threshold distance d1 based on the user height information. The electronic apparatus 100 may calculate the first threshold distance d1 by applying a first constant a to user height information h. The first constant a may be a value between zero and 1. The first constant a may be changed based on the user setting.

At least one processor 120 may perform the first mode for receiving the touch input based on the target distance being less than the first threshold distance.

At least one processor 120 may perform the second mode for receiving the motion input based on the target distance being greater than or equal to the first threshold distance.

At least one processor 120 may perform the third mode for receiving the voice input if the user is not recognized based on the first captured image.

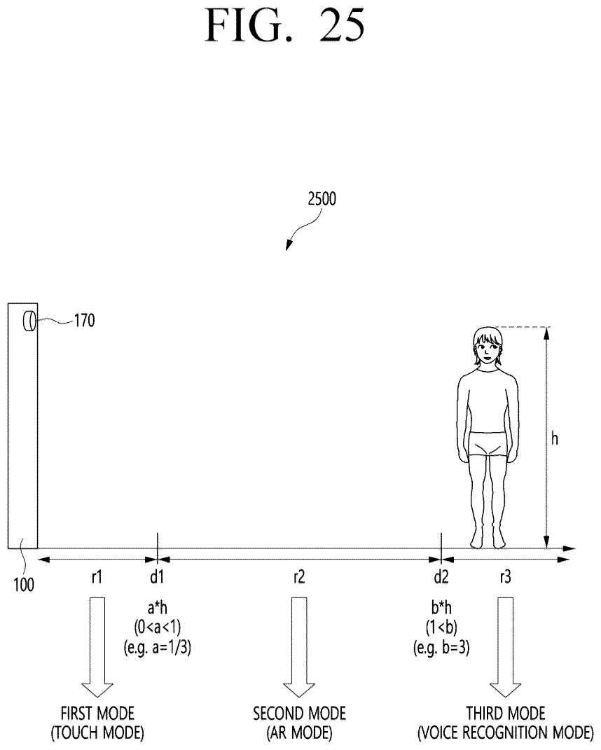

Operations for performing the first mode, the second mode, or the third mode are described with reference to FIGS. 25 to 32.

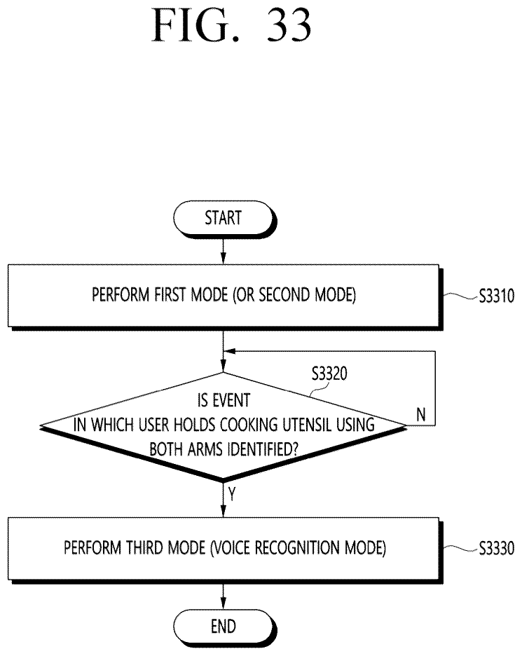

An operation in a situation where the user holds a cooking utensil using both arms is described with reference to FIGS. 33 to 35.

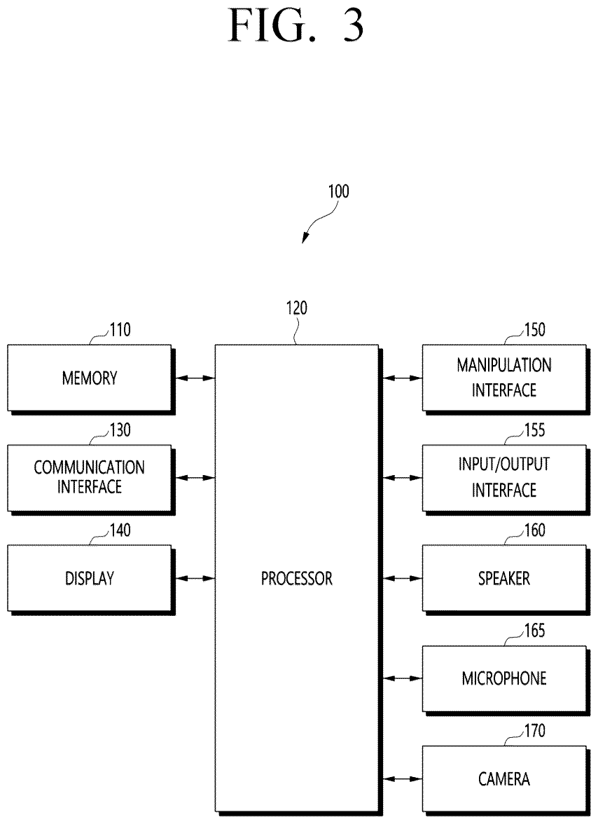

FIG. 3 is a block diagram for describing a configuration of the electronic apparatus 100 in FIG. 2 according to an embodiment.

Referring to FIG. 3, the electronic apparatus 100 may include at least one of the memory 110, at least one processor 120, a communication interface 130, the display 140, a manipulation interface 150, an input/output interface 155, a speaker 160, a microphone 165, or the camera 170.

The memory 110 may be implemented as an internal memory such as a read-only memory (ROM, e.g., electrically erasable programmable read-only memory (EEPROM)) or a random access memory (RAM), included in at least one processor 120, or as memory separate from at least one processor 120. The memory 110 may be implemented in the form of memory embedded in the electronic apparatus 100 or in the form of memory detachable from the electronic apparatus 100, based on a data storage purpose. For example, data for driving the electronic apparatus 100 may be stored in the memory embedded in the electronic apparatus 100, and data for an extension function of the electronic apparatus 100 may be stored in the memory detachable from the electronic apparatus 100.

Meanwhile, the memory embedded in the electronic apparatus 100 may be implemented as at least one of a volatile memory (e.g., dynamic RAM (DRAM), static RAM (SRAM) or synchronous dynamic RAM (SDRAM)) or a non-volatile memory (e.g., one time programmable ROM (OTPROM), programmable ROM (PROM), erasable and programmable ROM (EPROM), electrically erasable and programmable ROM (EEPROM), a mask ROM, a flash ROM, a flash memory (e.g., NAND flash or NOR flash), a hard drive, or a solid state drive (SSD)); and the memory detachable from the electronic apparatus 100 may be implemented as a memory card (e.g., compact flash (CF), secure digital (SD), micro secure digital (Micro-SD), mini secure digital (mini-SD), extreme digital (xD), or multi-media card (MMC)), an external memory which may be connected to a universal serial bus (USB) port (e.g., USB memory), or the like.

The memory 110 may store at least one instruction. At least one processor 120 may perform various operations based on the instructions stored in the memory 110.

At least one processor 120 may be implemented as a digital signal processor (DSP) that processes a digital signal, a microprocessor, or a time controller (TCON). However, the processor 120 is not limited thereto, and may include at least one of a central processing unit (CPU), a micro controller unit (MCU), a micro processing unit (MPU), a controller, an application processor (AP), a graphics-processing unit (GPU), a communication processor (CP), or an advanced reduced instruction set computer (RISC) machine (ARM) processor, or may be defined by these terms. At least one processor 120 may be implemented as a system-on-chip (SoC), in which a processing algorithm is embedded, a large scale integration (LSI), or may be implemented in the form of a field programmable gate array (FPGA). At least one processor 120 may perform various functions by executing computer executable instructions stored in the memory.

The communication interface 130 may be a component that communicates with the various types of external devices by using various types of communication methods. The communication interface 114 may include a wireless communication module or a wired communication module. Each communication module may be implemented in the form of at least one hardware chip.

The wireless communication module may be a module that communicates with the external device in a wireless manner. For example, the wireless communication module may include at least one of a wireless-fidelity (Wi-Fi) module, a Bluetooth module, an infrared communication module, or other communication modules.

The Wi-Fi module and the Bluetooth module may respectively perform the communication in a Wi-Fi manner and a Bluetooth manner. In case of using the Wi-Fi module or the Bluetooth module, the communication interface may first transmit and receive various connection information such as a service set identifier (SSID) or a session key, connect the communication by using this connection information, and then transmit and receive various information.

The infrared communication module may perform the communication based on infrared data association (IrDA) technology that transmits data in a short distance in the wireless manner by using an infrared ray between visible and millimeter waves.

In addition to the above-described communication manners, other communication modules may include at least one communication chip performing the communication based on various wireless communication standards such as ZigBee, third generation (3G), third generation partnership project (3GPP), long term evolution (LTE), LTE advanced (LTE-A), fourth generation (4G), and fifth generation (5G).

The wired communication module may be a module communicating with the external device in a wired manner. For example, the wired communication module may include at least one of a local area network (LAN) module, an Ethernet module, a pair cable, a coaxial cable, an optical fiber cable, or an ultra wide-band (UWB) module.

According to an embodiment, the communication interface 130 may use the same communication module (for example, the Wi-Fi module) to communicate with the external device, such as a remote control device, and an external server.

According to an embodiment, the communication interface 130 may use a different communication module to communicate with the external device such as the remote control device or the external server. For example, the communication interface 130 may use at least one of the Ethernet module or the Wi-Fi module to communicate with the external server, and may use the Bluetooth module to communicate with the external device such as the remote control device. However, this case is only an example, and the communication interface 130 may use at least one communication module among various communication modules in case of communicating with the plurality of external devices or external servers.

The display 140 may be implemented as various types of displays such as a liquid crystal display (LCD), an organic light emitting diode (OLED) display, a plasma display panel (PDP). The display 140 may include a driving circuit, a backlight unit, and the like, which may be implemented in a form such as an amorphous silicon thin film transistor (a-si TFT), a low temperature poly silicon (LTPS) TFT, or an organic TFT (OTFT). The display may be implemented in a touch screen combined with a touch sensor, a flexible display, a three-dimensional (3D) display, or the like. According to an embodiment of the present disclosure, the display 140 may include a bezel housing a display panel as well as the display panel outputting the image. The bezel may include the touch sensor detecting user interaction according to an embodiment of the present disclosure.

The manipulation interface 150 may be implemented as a device such as a button, a touch pad, a mouse or a keyboard, or may be implemented in a touchscreen capable of also performing an operation input function in addition to the above-described display function. The button may be any of various types of buttons such as a mechanical button, a touch pad, a wheel or the like, which is positioned in any region, such as a front surface portion, a side surface portion or a rear surface portion, of a body appearance of the electronic apparatus 100.

The input/output interface 155 may be any of a high definition multimedia interface (HDMI), a mobile high-definition link (MHL), a universal serial bus (USB), a display port (DP), Thunderbolt, a video graphics array (VGA) port, a red-green-blue (RGB) port, a D-subminiature (D-SUB) or a digital visual interface (DVI). The input/output interface 155 may input/output at least one of audio or video signals. According to an implementation example, the input/output interface 155 may include a port for inputting and outputting only the audio signal and a port for inputting and outputting only the video signal as its separate ports, or may be implemented as a single port for inputting and outputting both the audio signal and the video signal. The electronic apparatus 100 may transmit at least one of the audio signal or the video signal to the external device (for example, the external display device or an external speaker) through the input/output interface 155. An output port included in the input/output interface 155 may be connected to the external device, and the electronic apparatus 100 may transmit at least one of the audio signal or the video signal to the external device through the output port.

The input/output interface 155 may be connected to the communication interface. The input/output interface 155 may transmit information received from the external device to the communication interface, or transmit information received through the communication interface to the external device.

The speaker 160 may be a component for outputting various audio data as well as various notification sounds or voice messages.

The microphone 165 may be a component for receiving a user voice or another sound, and converting the same into the audio data. The microphone 165 may receive the user voice while activated. For example, the microphone 165 may be integrated with the upper, front, side, or the like of the electronic apparatus 100. The microphone 165 may include various components such as a microphone collecting the user voice in an analog form, an amplifier circuit amplifying the collected user voice, an analog to digital (A/D) conversion circuit sampling the amplified user voice and converting the same into the digital signal, a filter circuit removing a noise component from the converted digital signal, and the like.

The camera 170 may be a component for capturing a subject and generating the captured image, and the captured image is a concept that includes both video and still images. The camera 170 may obtain the image of at least one external device, and may be implemented as the camera, a lens, an infrared sensor, or the like.

The camera 170 may include the lens and the image sensor. A type of lens may include a multi-purpose lens, a wide-angle lens, a zoom lens, or the like, and may be determined based on the type, feature, and usage environment of the electronic apparatus 100. The image sensor may use a complementary metal oxide semiconductor (CMOS), a charge coupled device (CCD), or the like.

FIG. 4 is a diagram for describing the operation for playing or stopping the content according to an embodiment.

Referring to FIG. 4, the electronic apparatus 100 may play the content (S410). The electronic apparatus 100 may perform a function for playing the content. The content may be selected by the user input. The electronic apparatus 100 may obtain the first captured image from the camera 170 (S420).

For example, the first captured image may include the plurality of captured images. The first captured image may include at least one captured image obtained before the first event is identified.

The electronic apparatus 100 may identify the head object of the user based on the first captured image. If the head object is identified, the electronic apparatus 100 may obtain the first rotation angle information of the head object (S430). The electronic apparatus 100 may obtain the degree of rotation of the head object of the user. The first rotation angle information may be information indicating the degree of the head rotation of the user.

The first rotation angle information may include at least one of a first rotation angle u or a first rotation angle change amount Δu.

The first rotation angle u may indicate an angle of the head rotation of the user identified at the first time point. The rotation angle may be identified based on at least one of the roll rotation angle, the pitch rotation angle, or the yaw rotation angle. For example, the first rotation angle u may be obtained based on at least one of the pitch rotation angle or the yaw rotation angle.

The first rotation angle change amount Δu may indicate a rotation angle change amount between the first time point and a previous time point. The previous time point may indicate the time point before the unit time based on the first time point. For example, if the unit time is one second, the first rotation angle change amount Δu may indicate the rotation angle change amount between the first time point and the time point before one second from the first time point.

Processes for calculating the first rotation angle u and the first rotation angle change amount Δu are described with reference to FIG. 10.

The electronic apparatus 100 may identify whether the first event occurs based on the first rotation angle information (S440). The first event may be a predetermined event.

For example, the first event may include an event in which the first rotation angle u is less than or equal to −30 degrees or the first rotation angle u is greater than or equal to 30 degrees.

For example, the first event may include an event in which the first rotation angle change amount Δu is less than or equal to −15 degrees or the first rotation angle change amount Δu is greater than or equal to 15 degrees.

For example, the first event may include an event that satisfies both the first condition, in which the first rotation angle u is less than or equal to −30 degrees or the first rotation angle u is greater than or equal to 30 degrees, and the second condition, in which the first rotation angle change amount Δu is less than or equal to −15 degrees or the first rotation angle change amount Δu is greater than or equal to 15 degrees.

If the first event is not identified (S440-N), the electronic apparatus 100 may repeat steps S410 to S440.

If the first event is identified (S440-Y), the electronic apparatus 100 may stop the content (S450). The stop operation may include a temporary stop operation. The stop operation may include an operation for stopping the content being played. After the content is stopped, the electronic apparatus 100 may obtain the second captured image from the camera 170 (S460).

For example, the second captured image may include the plurality of captured images. The second captured image may include at least one captured image obtained before the second event is identified.

The electronic apparatus 100 may identify the head object of the user based on the second captured image. If the head object is identified, the electronic apparatus 100 may obtain the second rotation angle information of the head object (S470). The electronic apparatus 100 may obtain the degree of rotation of the head object of the user. The second rotation angle information may be information indicating the degree of the head rotation of the user.

The second rotation angle information may include at least one of the second rotation angle u or the second rotation angle change amount Δu. To distinguish from the first rotation angle and the first rotation angle change amount, the second rotation angle or the second rotation angle change amount may be described as the second rotation angle (u2) or the second rotation angle change amount (Δu2).

The second rotation angle u may indicate an angle of the head rotation of the user identified at a second time point. The rotation angle may be identified based on at least one of the roll rotation angle, the pitch rotation angle, or the yaw rotation angle. For example, the second rotation angle u may be obtained based on at least one of the pitch rotation angle or the yaw rotation angle.

The second rotation angle change amount Δu may indicate a rotation angle change amount between the second time point and a previous time point. The previous time point may indicate a time point before the unit time based on the second time point. For example, if the unit time is one second, the second rotation angle change amount Δu may indicate the rotation angle change amount between the second time point and the time point before one second from the second time point.

Processes for calculating the second rotation angle u and the second rotation angle change amount Δu are described with reference to FIG. 10.

The electronic apparatus 100 may identify whether the second event occurs based on the second rotation angle information (S480). The second event may be a predetermined event.

For example, the second event may include an event in which the second rotation angle u exceeds −30 degrees and less than 30 degrees or the second rotation angle change amount Δu exceeds −15 degrees and less than 15 degrees.

For example, the second event may include an event in which the second rotation angle u exceeds −30 degrees and less than 30 degrees.

For example, the second event may include an event in which the second rotation angle change amount Δu exceeds −15 degrees and less than 15 degrees.

If the second event is not identified (S480-N), the electronic apparatus 100 may repeat steps S450 to S480.

If the second event is identified (S480-Y), the electronic apparatus 100 may play the content (S410). If the content is being played, the electronic apparatus 100 may re-perform steps S410 to S480.

FIG. 5 is a diagram for describing an operation for obtaining rotation angle information of a head object according to an embodiment.

Step S520 in FIG. 5 may correspond to step S420 in FIG. 4. Accordingly, for additional implementation details, reference may be made to the descriptions of FIG. 4. The electronic apparatus 100 may obtain the first captured image (S520).

The electronic apparatus 100 may identify the head object of the user based on the first captured image (S531). The electronic apparatus 100 may analyze the rotation angle of the head object based on the first captured image.

The electronic apparatus 100 may obtain the pitch rotation angle and yaw rotation angle of the head object (S532). The electronic apparatus 100 may not utilize the roll rotation angle. The reason is that the roll rotation of the head may be a behavior that does not reflect a user intention. For example, the roll rotation may be identified by a stretching operation of the user.

The electronic apparatus 100 may obtain the first value by multiplying the pitch rotation angle by a first weight w1 (S533).

The electronic apparatus 100 may obtain the second value by multiplying the yaw rotation angle by a second weight w2 (S534).

The electronic apparatus 100 may obtain the first rotation angle u by adding the first value to the second value (S535).

The electronic apparatus 100 may obtain the first rotation angle change amount Δu based on a difference between the first rotation angle u and a previous rotation angle (S536). The electronic apparatus 100 may obtain the first rotation angle u at the first time point. The electronic apparatus 100 may obtain the previous rotation angle at the time point previous to the first time point. The previous time point may be a time point previous to the unit time. The unit time may be a predetermined time. The unit time may be changed based on the user setting. For example, the unit time may be one second. The electronic apparatus 100 may obtain the difference between the first rotation angle u at the first time point and the rotation angle at the previous time point. The electronic apparatus 100 may obtain the difference by using a subtraction computation. The electronic apparatus 100 may obtain the first rotation angle change amount Δu based on the difference.

The electronic apparatus 100 may obtain the first rotation angle information including the first rotation angle u and the first rotation angle change amount Δu (S537).

The electronic apparatus 100 may obtain the first rotation angle information and then perform steps S440 to S480 in FIG. 4.

Steps S520 to S537 may be equally applied to the second captured image. An operation for obtaining the second rotation angle information may be the same as the operation for obtaining the first rotation angle information. Accordingly, for additional implementation details, reference may be made to the descriptions of the operation for obtaining the first rotation angle information.

FIG. 6 is a diagram for describing a reference for a rotation angle reference according to an embodiment.

Embodiment 600 in FIG. 6 shows a three-dimensional coordinate system.

The three-dimensional coordinate system may include an x-axis, a y-axis, and a z-axis to indicate a position.

The x-axis may be a virtual axis pointing front and rear sides with respect to a reference point p0. An x value may increase as a target 610 moves forward from the reference point p0. The x value may decrease as the target 610 moves backward from the reference point p0.

The y-axis may be a virtual axis pointing left and right sides with respect to the reference point p0. A y value may increase as the target 610 moves leftward from the reference point p0. The y value may decrease as the target 610 moves rightward from the reference point p0.

The z-axis may be a virtual axis pointing upper and lower sides with respect to the reference point p0. A z value may increase as the target 610 moves upward from the reference point p0. The z value may decrease as the target 610 moves downward from the reference point p0.

The x-axis, y-axis, and z-axis may be orthogonal to one another.

For example, the x-axis may be referred to as a first axis, the y-axis may be referred to as a second axis, and the z-axis may be referred to as a third axis.

The three-dimensional coordinate system may include the roll, pitch, and yaw axes to indicate a rotation state of an object.

Roll indicates an angle at which the object rotates around the x-axis with respect to the reference point p0.

Assume that the x-axis is viewed from the reference point p0. A roll value may increase as the target 610 rotates clockwise with respect to the reference point p0. The roll value may decrease as the target 610 rotates counterclockwise with respect to the reference point p0.

Pitch indicates an angle at which the object rotates around the y-axis with respect to the reference point p0.

Assume that the y-axis is viewed from the reference point p0. A pitch value may increase as the target 610 rotates clockwise with respect to the reference point p0. The pitch value may decrease as the target 610 rotates counterclockwise with respect to the reference point p0.

The pitch value may increase as the target 610 tilts downward from the reference point p0. The pitch value may decrease as the target 610 tilts upward from the reference point p0.

Yaw indicates an angle at which the object rotates around the z-axis with respect to the reference point p0.

Assume that the z-axis is viewed from the reference point p0. A yaw value may increase as the target 610 rotates clockwise with respect to the reference point p0. The yaw value may increase as the target 610 rotates leftward with respect to the reference point p0.

The yaw value may decrease as the target 610 rotates counterclockwise with respect to the reference point p0. The yaw value may decrease as the target 610 rotates rightward with respect to the reference point p0.

For example, the x-axis may be referred to as the roll axis, the y-axis may be referred to as the pitch axis, and the z-axis may be referred to as the yaw axis.

For example, the roll value may be referred to as a first rotation angle, the pitch value may be referred to as a second rotation angle, and the yaw value may be referred to as a third rotation angle.

For example, an angle at which rotation occurs may be referred to as the rotation angle or the rotation direction.

FIG. 7 is a diagram for describing the operation for stopping the content based on the head rotation according to an embodiment.

Referring to Embodiment 710 of FIG. 7, the electronic apparatus 100 may capture the user by using the camera 170. The electronic apparatus 100 may obtain a captured image 715 by using the camera 170. The electronic apparatus 100 may identify the head object of the user based on the captured image 715. The electronic apparatus 100 may obtain the rotation angle information of the head object based on the captured image 715. The electronic apparatus 100 may provide a guide UI 711 corresponding to the rotation angle information of the head object. The electronic apparatus 100 may display the guide UI 711 on the currently displayed screen.

For example, it is assumed that the electronic apparatus 100 is playing the content. It is assumed that the user is facing the front side toward the display 140 of the electronic apparatus 100. The electronic apparatus 100 may maintain the content being played based on the captured image 715. The electronic apparatus 100 may display the guide UI 711 on the screen displaying the content being played. The electronic apparatus 100 may provide the guide UI 711 in the pop-up form. The guide UI 711 may be a UI indicating that the user is facing the front side toward the display 140 of the electronic apparatus 100.

For example, the content may be one of content for education, content for lectures, or content for classes.

Referring to Embodiment 720 of FIG. 7, the electronic apparatus 100 may capture the user by using the camera 170. The electronic apparatus 100 may obtain a captured image 725 by using the camera 170. The electronic apparatus 100 may identify the head object of the user based on the captured image 725. The electronic apparatus 100 may obtain the rotation angle information of the head object based on the captured image 725. The electronic apparatus 100 may provide a guide UI 721 corresponding to the rotation angle information of the head object. The electronic apparatus 100 may display the guide UI 721 on the currently displayed screen.

For example, it is assumed that the electronic apparatus 100 is playing the content. It is assumed that the user is facing the front side toward the display 140 of the electronic apparatus 100. The electronic apparatus 100 may stop the content being played based on the captured image 725. The electronic apparatus 100 may display the guide UI 721 on the screen displaying the stopped content. The electronic apparatus 100 may provide the guide UI 721 in the pop-up form. The guide UI 721 may be a UI indicating that the user is facing downward with respect to the display 140 of the electronic apparatus 100.

Referring to Embodiment 730 of FIG. 7, the electronic apparatus 100 may capture the user by using the camera 170. The electronic apparatus 100 may obtain a captured image 735 by using the camera 170. The electronic apparatus 100 may identify the head object of the user based on the captured image 735. The electronic apparatus 100 may obtain the rotation angle information of the head object based on the captured image 735. The electronic apparatus 100 may provide a guide UI 731 corresponding to the rotation angle information of the head object. The electronic apparatus 100 may display the guide UI 731 on the currently displayed screen.

For example, it is assumed that the electronic apparatus 100 stops the content. It is assumed that the user is facing the front side toward the display 140 of the electronic apparatus 100. The electronic apparatus 100 may play the content based on a captured image 735. The electronic apparatus 100 may display a guide UI 731 on a screen displaying the content being played. The electronic apparatus 100 may provide the guide UI 731 in the pop-up form. The guide UI 731 may be a UI indicating that the user is facing the front side toward the display 140 of the electronic apparatus 100. If the user is identified as facing the front side toward the display 140, the electronic apparatus 100 may play the stopped content again.

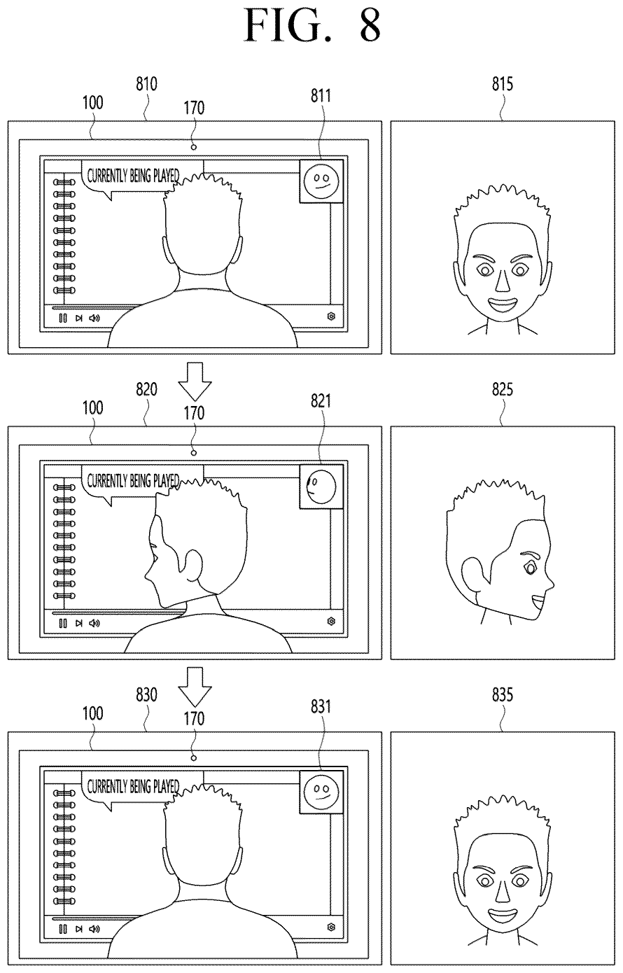

FIG. 8 is a diagram for describing the operation for stopping the content based on the head rotation according to an embodiment.

Embodiments 810, 820, and 830 of FIG. 8 may correspond to Embodiments 710, 720, and 730 of FIG. 7. Accordingly, for additional implementation details, reference may be made to the descriptions of FIG. 7.

Guide UIs 811, 821, and 831 in FIG. 8 may correspond to the guide UIs 711, 721, and 731 in FIG. 7. Accordingly, for additional implementation details, reference may be made to the descriptions of FIG. 7.

Captured images 815, 825, and 835 in FIG. 8 may correspond to the captured images 715, 725, and 735 in FIG. 7. Accordingly, for additional implementation details, reference may be made to the descriptions of FIG. 7.

The guide UI indicates the rotation information of the head object. For example, the electronic apparatus 100 may generate a guide UI reflecting information on the pitch rotation angle or yaw rotation angle of the head of the user. For example, the roll rotation angle may not be reflected in the guide UI.

Embodiment 720 of FIG. 7 shows a case where the user pitch-rotates his/her head. The electronic apparatus 100 may generate the guide UI 721 reflecting the pitch rotation of the head of the user.

Embodiment 820 of FIG. 8 shows a case where the user yaw-rotates his/her head. The electronic apparatus 100 may generate a guide UI 821 reflecting the yaw rotation of the head of the user.

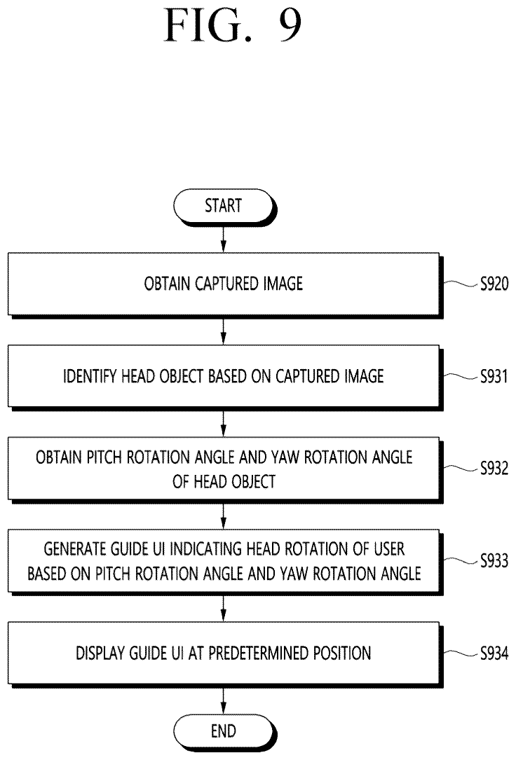

FIG. 9 is a diagram for describing a guide UI indicating the head rotation according to an embodiment.

Steps S920, S931, and S932 in FIG. 9 may correspond to steps S520, S531, and S532 in FIG. 5. Accordingly, for additional implementation details, reference may be made to the descriptions of FIG. 5.

After the pitch rotation angle and the yaw rotation angle of the head object are obtained, the electronic apparatus 100 may generate the guide UI based on the pitch rotation angle and the yaw rotation angle (S933).

The electronic apparatus 100 may generate the guide UI indicating the head rotation of the user based on the pitch rotation angle and the yaw rotation angle (S933).

The electronic apparatus 100 may display the guide UI at the predetermined position (S934). The predetermined position may be changed by the user setting.

The guide UIs may correspond to the guide UIs 711, 721, 731, 811, 821, and 831 in FIGS. 7 and 8. The guide UI may be displayed regardless of whether the content is played or stopped.

FIG. 10 is a diagram for describing an operation for calculating the head rotation angle according to an embodiment.

Based on Equation 1010 in FIG. 10, the electronic apparatus 100 may obtain the rotation angle u of the head object. The rotation angle u may be calculated by a predetermined function hpd(t). hpd(t) may be a function that uses at least one of the pitch rotation angle or the yaw rotation angle. The rotation angle u indicates angle information that synthesizes two rotation axes (for example, the pitch and yaw axes). Equation 1010 may be included in a head motion detection engine (or model). The electronic apparatus 100 may obtain the rotation angle u based on the head motion detection engine (or model).

Equation 1020 in FIG. 10 represents a predetermined function. w1 may be the first weight applied to the pitch rotation angle. w2 may be the second weight applied to the yaw rotation angle. For example, the sum of w1 and w2 may be 1.

Equation 1030 in FIG. 10 represents a function using only the pitch rotation angle. The electronic apparatus 100 may obtain the rotation angle u without considering either the roll rotation angle or the yaw rotation angle. Equation 1030 may be an equation obtained in a case where w2 is zero in Equation 1020. The electronic apparatus 100 may not consider either the roll rotation angle or the yaw rotation angle upon determining whether the content is to be played. As in Embodiment 820 of FIG. 8, even if the user rotates his/her head by the yaw rotation angle, the content may not be stopped.

Based on Equation 1040 in FIG. 10, the electronic apparatus 100 may obtain the rotation angle change amount Δu. The electronic apparatus 100 may obtain the rotation angle change amount Δu based on a difference between the rotation angle u at a first time point t and the rotation angle u at a previous time point t−1.

FIG. 11 is a diagram for describing a condition corresponding to the head rotation according to an embodiment.

Referring to FIG. 11, the electronic apparatus 100 may store an event table 1110. The event table 1110 may include information indicating at least one event. The event table 1110 may include condition information for identifying at least one event.

The event table 1110 may include the first event. The first event may be an event that satisfies at least one of the first condition or the second condition. The first condition may be satisfied based on first rotation angle u being less than or equal to a first threshold value th1 or the first rotation angle u being greater than or equal to a second threshold value th2. The second condition may be satisfied based on the first rotation angle change amount Δu being less than or equal to a third threshold value th3 or the first rotation angle change amount Δu being greater than or equal to a fourth threshold value th4.

The event table 1110 may include the second event. The second event may be an event that satisfies both the third condition, in which the second rotation angle u exceeds the first threshold value th1 and is less than the second threshold value th2, and the fourth condition, in which the second rotation angle change amount Δu exceeds the third threshold value th3 and is less than the fourth threshold value th4.

An event table 1120 may be a table in which the first threshold value is 30 degrees and the second threshold value is 15 degrees in the event table 1110.

The event table 1120 may include the first event. The first event may be an event that satisfies at least one of the first condition, in which the first rotation angle u is less than or equal to −30 degrees or the first rotation angle u is greater than or equal to 30 degrees, or the second condition, in which the first rotation angle change amount Δu is less than or equal to −15 degrees or the first rotation angle change amount Δu is greater than or equal to 15 degrees.

The event table 1120 may include the second event. The second event may be an event that satisfies both the third condition, in which the second rotation angle u exceeds −30 degrees and is less than 30 degrees, and the fourth condition, in which the second rotation angle change amount Δu exceeds −15 degrees and is less than 15 degrees.

The electronic apparatus 100 may identify whether the corresponding condition occurs during a threshold time upon determining the first event or the second event. If the condition is satisfied for the threshold time or more, the electronic apparatus 100 may identify that the event occurs. The threshold time may be a predetermined time. The threshold time may be changed by the user setting. A reason for considering the threshold time is that the user may habitually turn his/her head. The electronic apparatus 100 may not stop the content by a temporary behavior of turning his/her head.

FIG. 12 is a diagram for describing an operation for displaying the augmented reality (AR) UI according to an embodiment.

Referring to FIG. 12, the electronic apparatus 100 may obtain the captured image (S1220). For example, step S1220 may correspond to steps S420 and S460 in FIG. 4.

The electronic apparatus 100 may identify the hand and foot objects of the user in the captured image (S1231).

The electronic apparatus 100 may identify the first candidate region corresponding to a position of the hand object and the second candidate region corresponding to a position of the foot object (S1240). The hand object may have a position differently identified based on a user height. Therefore, the user height information may be reflected in the operation for identifying the first candidate region and the second candidate region.

The electronic apparatus 100 may identify a first candidate position included in the first candidate region and a second candidate position included in the second candidate region (S1250). The electronic apparatus 100 may determine the target position between the first candidate position and the second candidate position (S1260). The electronic apparatus 100 may determine the target position among the plurality of positions.

For example, the electronic apparatus 100 may determine a position corresponding to a predetermined body part of the user as the target position.

For example, the electronic apparatus 100 may determine the target position based on a user selection.

For example, the electronic apparatus 100 may determine the target position based on an event related to the user. If the user identifies an event in which the user is unable to use both arms, the electronic apparatus 100 may determine the target position in the second candidate region corresponding to the foot object.

The electronic apparatus 100 may display the augmented reality UI at the target position (S1270). The target position may be a position for displaying the augmented reality UI. The augmented reality UI may include at least one of an AR button, an AR icon, an AR image, an AR item, or an AR emoji.

FIG. 13 is a diagram for describing the guide screen for body analysis according to an embodiment.

Referring to FIG. 13, the electronic apparatus 100 may capture the user by using the camera 170. The electronic apparatus 100 may obtain the captured image including the user. The electronic apparatus 100 may analyze the user based on the captured image. The electronic apparatus 100 may display a guide screen 1300 for analyzing the user.

For example, the guide screen 1300 may include a UI 1310 displaying information for guiding the body analysis. The UI 1310 may include information for guiding a predetermined motion to the user. For example, the UI 1310 may include “Start body analysis. Please spread your arms.” The predetermined motion may be referred to as a predetermined posture.

The guide screen 1300 may include the captured image including the user. The electronic apparatus 100 may display the captured user on the guide screen 1300. The user may see himself/herself on the guide screen 1300.

FIG. 14 is a diagram for describing operations for displaying the augmented reality UI and identifying the candidate region according to an embodiment.

Referring to FIG. 14, the electronic apparatus 100 may display a screen 1400 displaying the candidate region for displaying the augmented reality UI.

The screen 1400 may include at least one of a UI 1410 indicating a body analysis result of the user and a UI 1420 indicating the candidate region.

The UI 1410 may include the user height information.

The UI 1420 may include at least one of the first candidate region 1421 corresponding to the hand object of the user and the second candidate region 1422 corresponding to a foot object of the user. The first candidate region 1421 may include a position at which the hand object of the user is identified. The second candidate region 1422 may include a position at which the foot object of the user is identified.

For example, the UI 1420 may include the captured image including the user. The electronic apparatus 100 may display the captured user through the UI 1420. The user may see himself/herself through the UI 1420.

FIG. 15 is a diagram for describing an operation for identifying the candidate position according to an embodiment.

UIs 1510 and 1520 in FIG. 15 may correspond to the UIs 1410 and 1420 in FIG. 14. Accordingly, for additional implementation details, reference may be made to the descriptions of FIG. 14.

Candidate regions 1521 and 1522 in FIG. 15 may correspond to the candidate regions 1421 and 1422 in FIG. 14. Accordingly, for additional implementation details, reference may be made to the descriptions of FIG. 14.

The electronic apparatus 100 may segment the candidate region. The electronic apparatus 100 may segment the candidate region based on a predetermined criterion. The segmented region may be referred to as the candidate position. The electronic apparatus 100 may display a screen 1500 including the candidate position.

The predetermined criterion may be a region for displaying the augmented reality UI among the candidate regions. The predetermined criterion may be changed by the user setting. For example, the predetermined criterion may be the leftmost region, the middle region, or the rightmost region among the candidate regions.

The electronic apparatus 100 may segment a first candidate region 1521 into a plurality of candidate positions 1521-1, 1521-2, and 1521-3. The electronic apparatus 100 may segment a second candidate region 1522 into a plurality of candidate positions 1522-1, 1522-2, and 1522-3.

The electronic apparatus 100 may display the screen 1500 including the UI 1520 indicating the plurality of candidate positions.

FIG. 16 is a diagram for describing the target position for displaying the augmented reality UI according to an embodiment.

Referring to FIG. 16, the electronic apparatus 100 may display a screen 1600 displaying the target position for displaying the augmented reality UI.

For example, the screen 1600 may display a UI 1610 for changing the target position at which the augmented reality UI is displayed. The UI 1610 may include information for guiding that the target position is changeable. The UI 1610 may not be displayed in some embodiments.

Candidate regions 1621 and 1622 and candidate positions 1621-1, 1621-2, 1621-3, 1622-1, 1622-2, and 1622-3 shown in FIG. 16 may correspond to the candidate regions 1521 and 1522 and the candidate positions 1521-1, 1521-2, 1521-3, 1522-1, 1522-2, and 1522-3 shown in FIG. 15. Accordingly, for additional implementation details, reference may be made to the descriptions of FIG. 15.

The electronic apparatus 100 may determine the target position among the candidate regions. The electronic apparatus 100 may determine the target position from one of the candidate positions. The target position may be the center point of the candidate position. The electronic apparatus 100 may determine the target position based on the predetermined criterion. The predetermined criterion may be a predetermined position.

For example, the predetermined criterion may be a rightmost region 1621 among the first candidate regions corresponding to the hand object. The electronic apparatus 100 may determine a candidate position 1621-3 as the target position based on the predetermined criterion.

The electronic apparatus 100 may distinguish the candidate position 1621-3 from the other regions and display the candidate position 1621-3 including the target position. For example, the electronic apparatus 100 may display only the candidate position 1621-3 in a predetermined color.

FIG. 17 is a diagram for describing an operation for changing the target position according to an embodiment.

Referring to FIG. 17, the electronic apparatus 100 may display a screen 1700 displaying a changed target position.

For example, the screen 1700 may display a UI 1710 for changing the target position at which the augmented reality UI is displayed. The UI 1710 may include information for requesting confirmation of the changed target position. The UI 1710 may not be displayed in some embodiments.

Candidate regions 1721 and 1722 and candidate positions 1721-1, 1721-2, 1721-3, 1722-1, 1722-2, and 1722-3 shown in FIG. 17 may correspond to the candidate regions 1621 and 1622 and the 1621-1, 1621-2, 1621-3, 1622-1, 1622-2, and 1622-3 shown in FIG. 16. Accordingly, for additional implementation details, reference may be made to the descriptions of FIG. 16.

For example, assume that the user changes the target position. The electronic apparatus 100 may display only a candidate position 1722-1 including the target position in the predetermined color.

For example, the electronic apparatus 100 may determine the target position based on a region where a right hand of the user is positioned for the threshold time or more.

FIG. 18 is a diagram for describing an operation for determining a size of the augmented reality UI according to an embodiment.

Step S1860 in FIG. 18 may correspond to step S1260 in FIG. 12. Steps S1220 to S1250 in FIG. 12 may be performed before step S1860. Accordingly, for additional implementation details, reference may be made to the descriptions of FIG. 12.

The electronic apparatus 100 may obtain the target distance between the electronic apparatus 100 and the user (S1871). Various methods for obtaining the target distance may be provided.

For example, the electronic apparatus 100 may obtain the target distance based on the captured image.

For example, the electronic apparatus 100 may obtain the target distance by using a distance sensor. The electronic apparatus 100 may include the distance sensor. For example, the distance sensor may be one of an ultrasonic sensor, an infrared sensor, or a time of flight (ToF) sensor.

The electronic apparatus 100 may obtain the user height information based on the captured image (S1872). The electronic apparatus 100 may identify a human object indicating the user in the captured image. The electronic apparatus 100 may estimate a height of the human object. The electronic apparatus 100 may store the estimated height as the user height information.

For example, the electronic apparatus 100 may obtain the user height information based on the target distance and an object size.

The electronic apparatus 100 may determine the target size in the augmented reality UI based on at least one of the target distance or the user height information (S1873).

For example, the electronic apparatus 100 may display the augmented reality UI smaller as the target distance is longer.

For example, the electronic apparatus 100 may display the augmented reality UI smaller as the user height is smaller.

The electronic apparatus 100 may display the augmented reality UI having the target size at the target position (S1874).

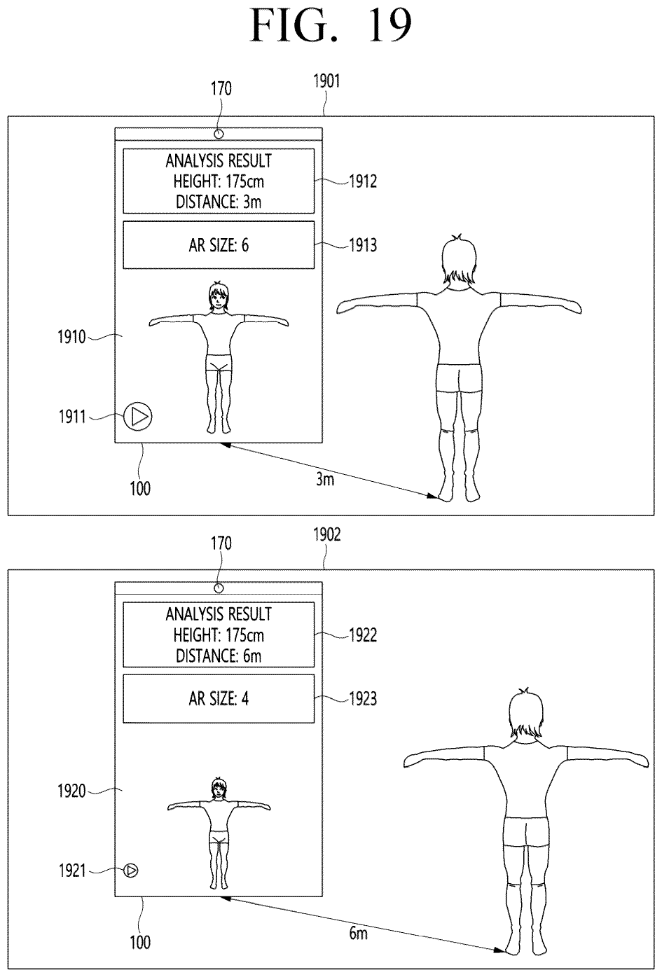

FIG. 19 is a diagram for describing an operation for determining a size of the augmented reality UI based on the distance between the user and the electronic apparatus according to an embodiment.

Referring to FIG. 19, the electronic apparatus 100 may determine the size of the augmented reality UI based on the target distance between the electronic apparatus 100 and the user. If the user height information is the same, the electronic apparatus 100 may display the augmented reality UI smaller as the target distance is longer.

Referring to Embodiment 1901 of FIG. 19, the electronic apparatus 100 may identify the target distance as a first distance (e.g., 3 m). The electronic apparatus 100 may display a screen 1910 displaying an augmented reality UI 1911 corresponding to the target distance and set to a first size.

For example, the screen 1910 may include at least one of a UI 1912 indicating the analysis result of the user or a UI 1913 indicating the size of the augmented reality UI. The UI 1912 may include at least one of the target distance or the user height information.

Referring to Embodiment 1902 of FIG. 19, the electronic apparatus 100 may identify the target distance as a second distance (e.g., 6 m). The electronic apparatus 100 may display a screen 1920 displaying an augmented reality UI 1921 corresponding to the target distance and set to a second size. If the second distance is longer than the first distance, the second size may be smaller than the first size.

For example, the screen 1920 may include at least one of a UI 1922 indicating the analysis result of the user and a UI 1923 indicating the size of the augmented reality UI. The UI 1922 may include at least one of the target distance or the user height information.

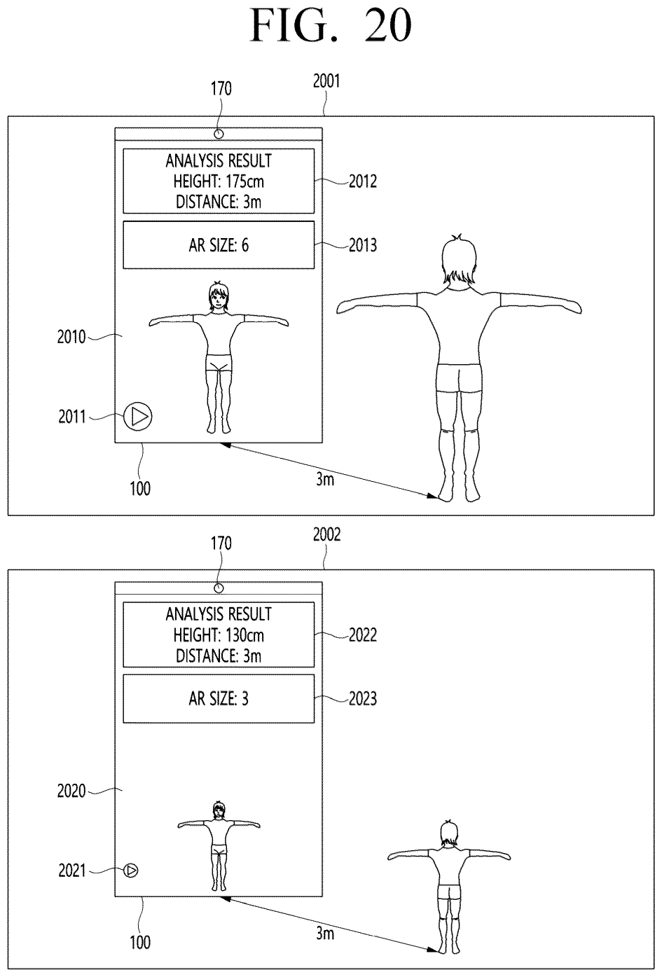

FIG. 20 is a diagram for describing an operation for determining the size of the augmented reality UI based on the user height information according to an embodiment.

Referring to FIG. 20, the electronic apparatus 100 may determine the size of the augmented reality UI based on the user height information. If the target distance is the same, the electronic apparatus 100 may display the augmented reality UI smaller as the user height information is smaller.

Referring to Embodiment 2001 of FIG. 20, the electronic apparatus 100 may identify the user height information as a first height (e.g., 175 cm). The electronic apparatus 100 may display a screen 2010 displaying an augmented reality UI 2011 corresponding to the user height information and set to a third size.

For example, the screen 2010 can include at least one of a UI 2012 indicating the analysis result of the user or a UI 2013 indicating the size of the augmented reality UI. The UI 2012 may include at least one of the user height information or distance information between the electronic apparatus 100 and the user.

Referring to Embodiment 2002 of FIG. 20, the electronic apparatus 100 may identify the user height information as a second height (e.g., 130 cm). The electronic apparatus 100 may display a screen 2020 displaying an augmented reality UI 2021 corresponding to the user height information and set to a fourth size. If the second height is smaller than the first height, the fourth size may be smaller than the third size.

For example, the screen 2020 may include at least one of a UI 2022 indicating the analysis result of the user and a UI 2023 indicating the size of the augmented reality UI. The UI 2022 may include at least one of the target distance or the user height information.

FIG. 21 is a diagram for describing an operation for displaying the augmented reality UI at a position based on an event according to an embodiment.

Step S2150 in FIG. 21 may correspond to step S1250 in FIG. 12. Steps S1220 to S1250 in FIG. 12 may be performed before step S2150. Accordingly, for additional implementation details, reference may be made to the descriptions of FIG. 12.

If the first candidate position and the second candidate position are identified, the electronic apparatus 100 may determine whether an event in which the user holds an exercise device using both arms is identified (S2155). The electronic apparatus 100 may identify an event related to the user in the captured image. The electronic apparatus 100 may analyze the captured image to identify whether the user holds an object representing the exercise device using both arms. If the user holds the exercise device, it may be difficult for the user to use both the arms. The electronic apparatus 100 may display the augmented reality UI in the second candidate region corresponding to the foot object rather than the hand object.

If the event is identified in step S2155 (S2155-Y), the electronic apparatus 100 may determine the target position based on the second candidate position in the second candidate region (S2160). The electronic apparatus 100 may display the augmented reality UI at the target position (S2170).

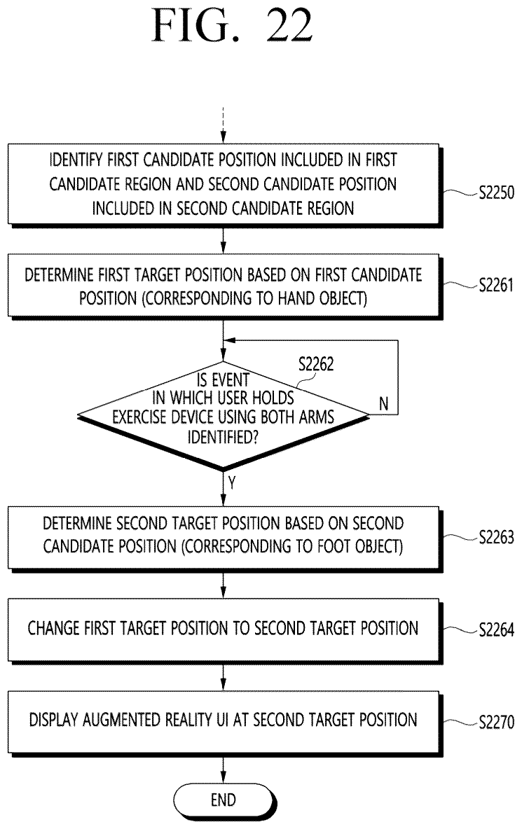

FIG. 22 is a diagram for describing an operation for displaying the augmented reality UI at a position based on an event according to an embodiment.

Step S2250 in FIG. 22 may correspond to step S1250 in FIG. 12. Steps S1220 to S1250 in FIG. 12 may be performed before step S2250. Accordingly, for additional implementation details, reference may be made to the descriptions of FIG. 12.

The electronic apparatus 100 may determine a first target position based on the first candidate position (S2261). The electronic apparatus 100 may determine the target position from the first candidate region corresponding to the hand object.

The electronic apparatus 100 may determine whether the event in which the user holds the exercise device using both arms is identified (S2262). The electronic apparatus 100 may identify the event related to the user in the captured image. The electronic apparatus 100 may analyze the captured image to identify whether the user holds the object representing the exercise device using both arms. If the user holds the exercise device, it may be difficult for the user to use both arms. The electronic apparatus 100 may change the target position in the augmented reality UI.

If the event is identified in step S2255 (S2255-Y), the electronic apparatus 100 may determine a second target position based on the second candidate position (S2263). The second target position may be a position included in the second candidate region corresponding to the foot object. The electronic apparatus 100 may display the augmented reality UI at the second target position (S2270).

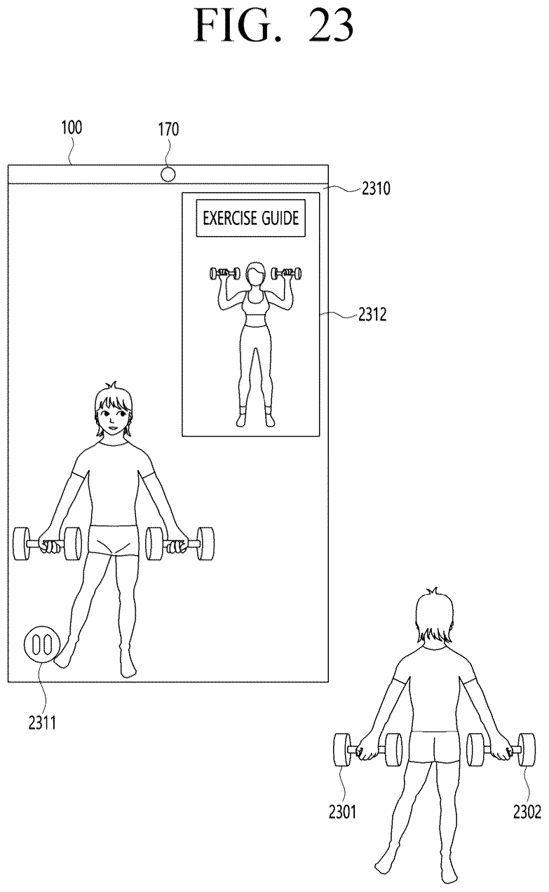

FIG. 23 is a diagram for describing an operation for displaying the augmented reality UI at a position according to an embodiment.

Referring to FIG. 23, the electronic apparatus 100 may display a screen 2310 including an augmented reality UI 2311. It is assumed that the user holds exercise devices 2301 and 2302 by using both hands.

If an event that the user holds the exercise devices 2301 and 2302 by using both hands is identified, the electronic apparatus 100 may display the augmented reality UI 2311 in the second candidate region of the user.

For example, the screen 2310 may include a UI 2312 including exercise content.

For example, the screen 2310 may include the captured image including the user. The electronic apparatus 100 may display the captured user on the screen 2310. The user may see his/her own image on the screen 2310.

If a motion of the user for selecting the augmented reality UI 2311 is identified, the electronic apparatus 100 may perform an operation corresponding to the augmented reality UI 2311.

For example, the augmented reality UI 2311 may be a UI for pausing the exercise content. If the motion of the user for selecting the augmented reality UI 2311 is identified, the electronic apparatus 100 may stop the exercise content provided through the UI 2312.

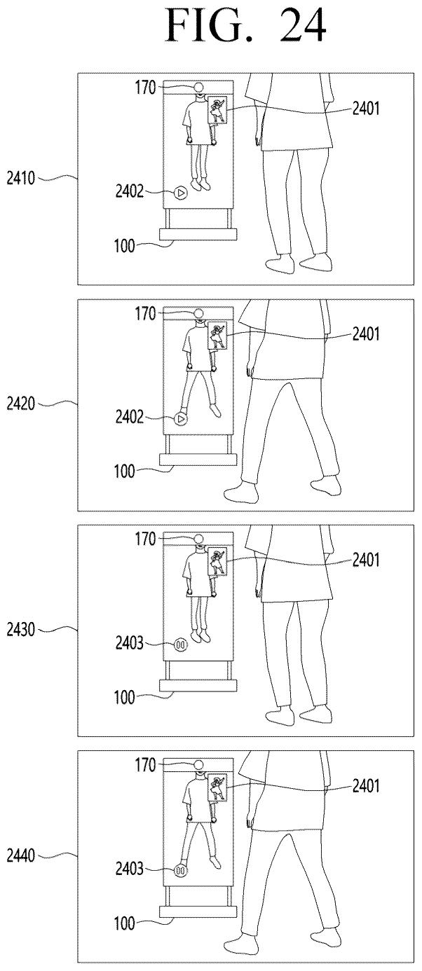

FIG. 24 is a diagram for describing an operation for playing or stopping content through the augmented reality UI according to an embodiment.

Referring to Embodiment 2410 of FIG. 24, the electronic apparatus 100 may display a UI 2401 indicating the content and an augmented reality UI 2402. It is assumed that the content is in a stopped state. The augmented reality UI 2402 may be a UI for playing the content.

Referring to Embodiment 2420 of FIG. 24, the electronic apparatus 100 may identify a motion of the user for selecting an augmented reality UI 2402. If the user selects the augmented reality UI 2402, the electronic apparatus 100 may play the content.

Referring to Embodiment 2430 of FIG. 24, the electronic apparatus 100 may display a new augmented reality UI 2403 based on the content being played. The augmented reality UI 2403 may be a UI for stopping the content.

Referring to Embodiment 2440 of FIG. 24, the electronic apparatus 100 may identify a motion of the user for selecting the augmented reality UI 2403. If the user selects the augmented reality UI 2403, the electronic apparatus 100 may stop the content.

FIG. 25 is a diagram for describing an operation for determining a mode in consideration of the user height and a user position according to an embodiment.

Referring to Embodiment 2500 of FIG. 25, the electronic apparatus 100 may perform various operation modes. For example, the modes may include at least one of the first mode (touch mode), the second mode (AR mode), or the third mode (voice recognition mode). The mode may be referred to as a state.

The first mode may be a mode for controlling the electronic apparatus 100 based on the user touch input. The electronic apparatus 100 may receive the user touch input. The electronic apparatus 100 may execute the first mode to perform a control operation corresponding to the touch input. The electronic apparatus 100 may include a touch sensor for receiving the touch input. The touch sensor may be included in a touch display.

The second mode may be a mode for controlling the electronic apparatus 100 by receiving the user motion input. The electronic apparatus 100 may receive the user motion input. The electronic apparatus 100 may execute the second mode to perform a control operation corresponding to the motion input. The electronic apparatus 100 may include a motion sensor for receiving the motion input. For example, the motion sensor may be implemented as the camera 170. For example, the motion sensor may be implemented as the image sensor different from the camera 170.

The third mode may be a mode for controlling the electronic apparatus 100 by receiving the user voice input. The electronic apparatus 100 may receive the user voice input. The electronic apparatus 100 may execute the third mode to perform a control operation corresponding to the voice input. The electronic apparatus 100 may include the microphone 165 for receiving the voice input.

The electronic apparatus 100 may store the plurality of available modes in the memory 110. The electronic apparatus 100 may determine one mode from the plurality of modes. The electronic apparatus 100 may determine one mode based on the target distance. The electronic apparatus 100 may identify the distance between the electronic apparatus 100 and the user as the target distance.

The electronic apparatus 100 may perform the first mode if the target distance is less than the first threshold distance d1.

The electronic apparatus 100 may perform the second mode if the target distance is greater than or equal to the first threshold distance d1 and less than a second threshold distance d2.

The electronic apparatus 100 may perform the third mode if the target distance is greater than or equal to the second threshold distance d2.

The electronic apparatus 100 may obtain the user height information. The electronic apparatus 100 may obtain a user height value.

For example, the electronic apparatus 100 may determine the first threshold distance d1 based on the user height information. The electronic apparatus 100 may calculate the first threshold distance d1 by applying the first constant a to the user height information h. The first constant a may be the value between zero and 1. The first constant a may be changed based on the user setting. For example, the first constant a may be ⅓.

For example, the electronic apparatus 100 may determine the second threshold distance d2 based on the user height information. The electronic apparatus 100 may calculate the second threshold distance d2 by applying a second constant b to the user height information h. The second constant b may be a value greater than 1. The second constant b may be changed based on the user setting. For example, the second constant b may be 3.

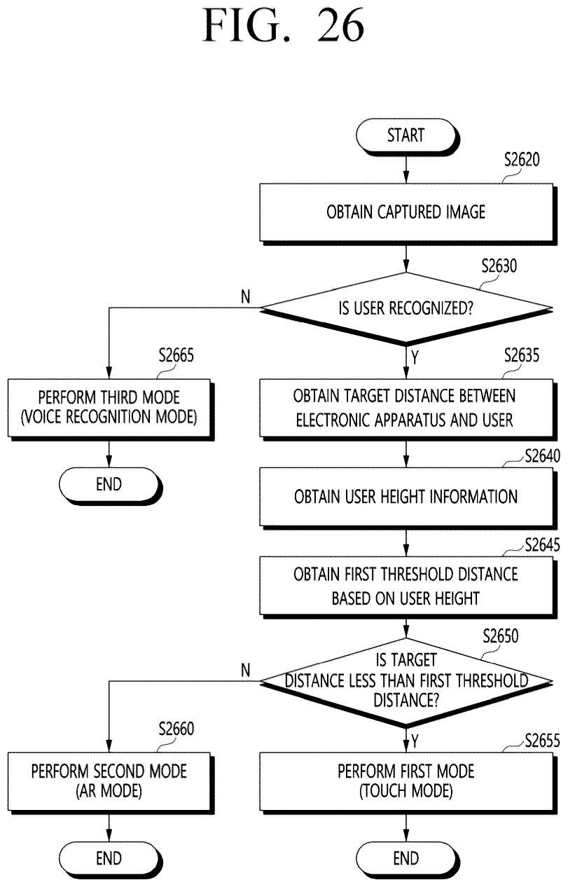

FIG. 26 is a diagram for describing an operation for determining a mode to be executed according to an embodiment.

Referring to FIG. 26, the electronic apparatus 100 may obtain the captured image (S2620). For example, step S2620 may correspond to steps S420 and S460 in FIG. 4.

The electronic apparatus 100 may identify whether the user is recognized based on the captured image (S2630). The electronic apparatus 100 may determine whether the human object representing the user is identified in the captured image.

If the user is recognized (S2630-Y), the electronic apparatus 100 may obtain the target distance between the electronic apparatus 100 and the user (S2635). Step S2365 may correspond to step S1871 in FIG. 18.

The electronic apparatus 100 may obtain the user height information (S2640). Step S2640 may correspond to step S1872 in FIG. 18.

The electronic apparatus 100 may obtain the first threshold distance d1 based on the user height information (S2645). The user height information may include a user height value h. The electronic apparatus 100 may obtain the first threshold distance d1 by multiplying the user height value h by the first constant a. The first constant a may be greater than 0 and less than 1.

The electronic apparatus 100 may identify whether the target distance is less than the first threshold distance d1 (S2650). The electronic apparatus 100 may perform the first mode (S2655) if the target distance is less than the first threshold distance d1 (S2650-Y).

The electronic apparatus 100 may perform the second mode (S2660) if the target distance is greater than or equal to the first threshold distance d1 (S2650-N).

The electronic apparatus 100 may perform the third mode (S2665) if the user is not recognized (S2630-N).

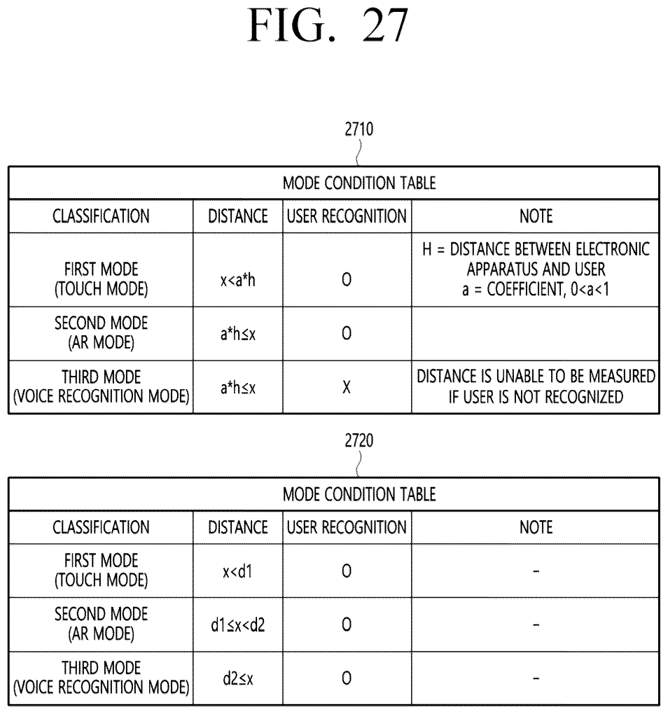

FIG. 27 is a diagram for describing a condition for performing the mode according to an embodiment.

A mode condition table 2710 in FIG. 27 may include a condition for performing the first mode. For example, the electronic apparatus 100 may perform the first mode if the first condition, in which the target distance is less than a first threshold distance a*h, and the second condition, in which the user is recognized, are both satisfied. “a” may be a constant between zero and 1. “h”may be the user height value included in the user height information.

The mode condition table 2710 may include a condition for performing the second mode. For example, the electronic apparatus 100 may perform the second mode if the third condition, in which the target distance is greater than or equal to the first threshold distance a*h, and the second condition, in which the user is recognized, are both satisfied.

The mode condition table 2710 may include a condition for performing the third mode. For example, the electronic apparatus 100 may perform the third mode if the third condition, in which the target distance is greater than or equal to the first threshold distance a*h, and the fourth condition, in which the user is not recognized, are both satisfied. The electronic apparatus 100 may be controlled using voice recognition if the user is not recognized.

A mode condition table 2720 in FIG. 27 may include a condition for performing the first mode. For example, the electronic apparatus 100 may perform the first mode if the first condition, in which the target distance is less than the first threshold distance d1, and the second condition, in which the user is recognized, are both satisfied.

The mode condition table 2720 may include a condition for performing the second mode. For example, the electronic apparatus 100 may perform the second mode if the third condition, in which the target distance is greater than or equal to the first threshold distance d1 and less than or equal to the second threshold distance d2, and the second condition, in which the user is recognized, are both satisfied.

The mode condition table 2720 may include a condition for performing the third mode. For example, the electronic apparatus 100 may perform the third mode if the fourth condition, in which the target distance is greater than or equal to the second threshold distance d2, and the second condition, in which the user is recognized, are both satisfied.

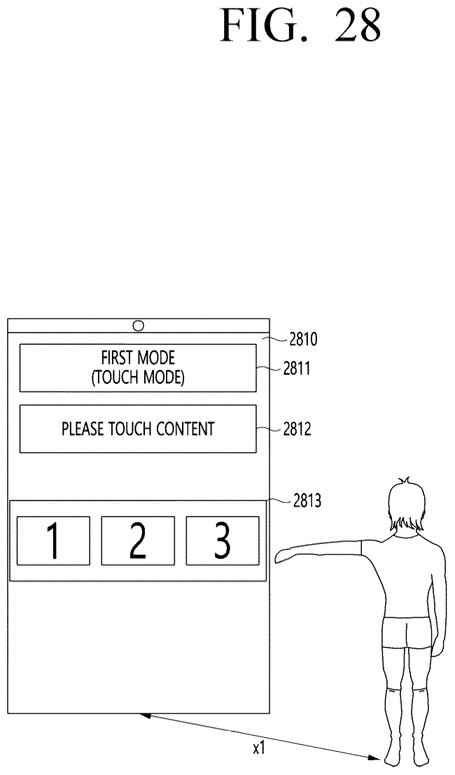

FIG. 28 is a diagram for describing the touch mode according to an embodiment.

Referring to FIG. 28, the electronic apparatus 100 may display a screen 2810 while performing the first mode. It is assumed that a target distance x1 satisfies the condition for performing the first mode.

The screen 2810 may include at least one of a UI 2811 indicating the first mode, a UI 2812 for guiding touching the content, or a content list UI 2813. The content list UI 2813 may include at least one content selectable by the user.

The electronic apparatus 100 may play the selected content if the user touch is received to select content through UI 2813.

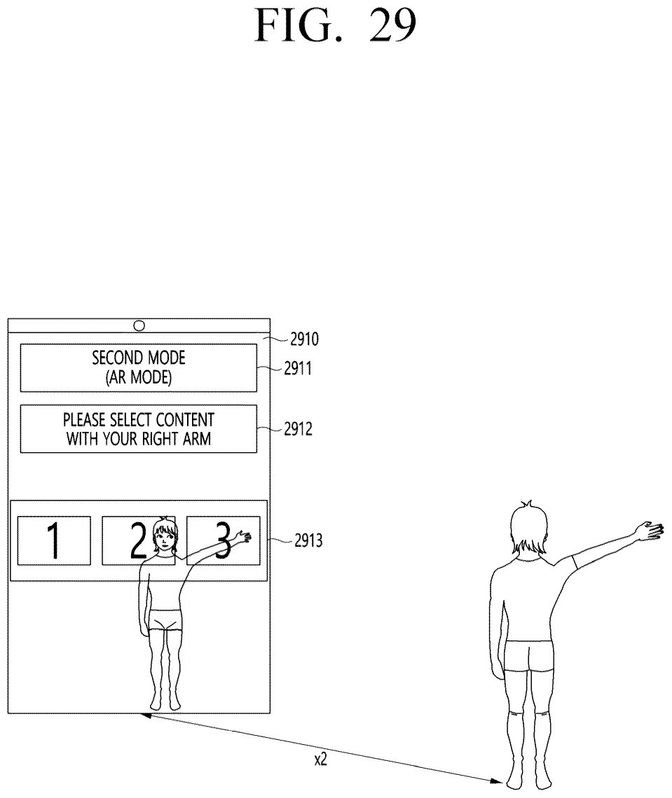

FIG. 29 is a diagram for describing the AR mode according to an embodiment.

Referring to FIG. 29, the electronic apparatus 100 may display a screen 2910 while performing the second mode. It is assumed that a target distance x2 satisfies the condition for performing the second mode.

The screen 2910 may include at least one of a UI 2911 indicating the second mode, a UI 2912 for guiding a motion for selecting the content, and a content list UI 2913. The content list UI 2913 may include at least one content selectable by the user.

The electronic apparatus 100 may play the selected content if the user motion for selecting content is received through the UI 2913.

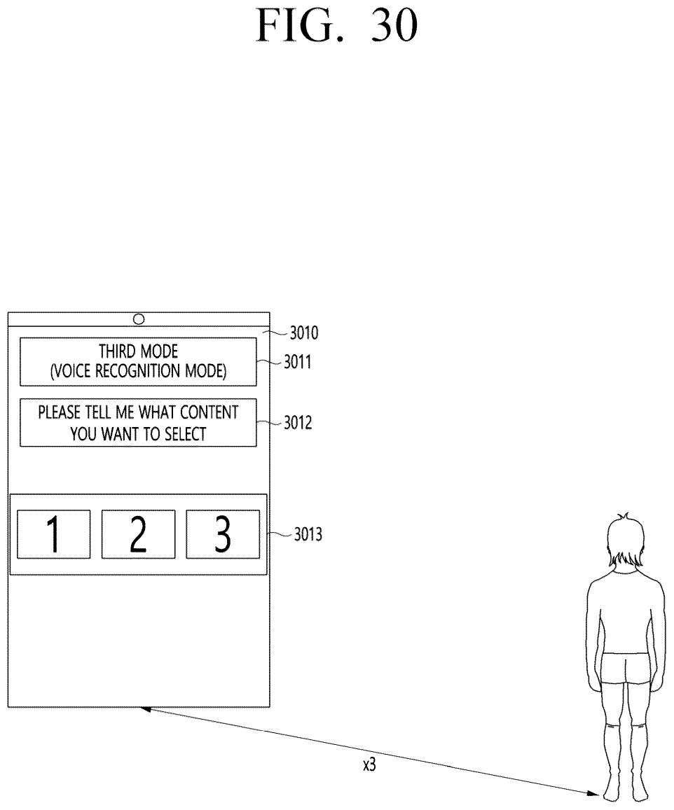

FIG. 30 is a diagram for describing the voice recognition mode according to an embodiment.

Referring to FIG. 30, the electronic apparatus 100 may display a screen 3010 while performing the third mode. It is assumed that a target distance x3 satisfies the condition for performing the third mode.

The screen 3010 may include at least one of a UI 3011 indicating the third mode, a UI 3012 for guiding a voice for selecting the content, and a content list UI 3013. The content list UI 3013 may include at least one content selectable by the user.

The electronic apparatus 100 may play the selected content if the user voice for selecting content is received through the UI 3013.

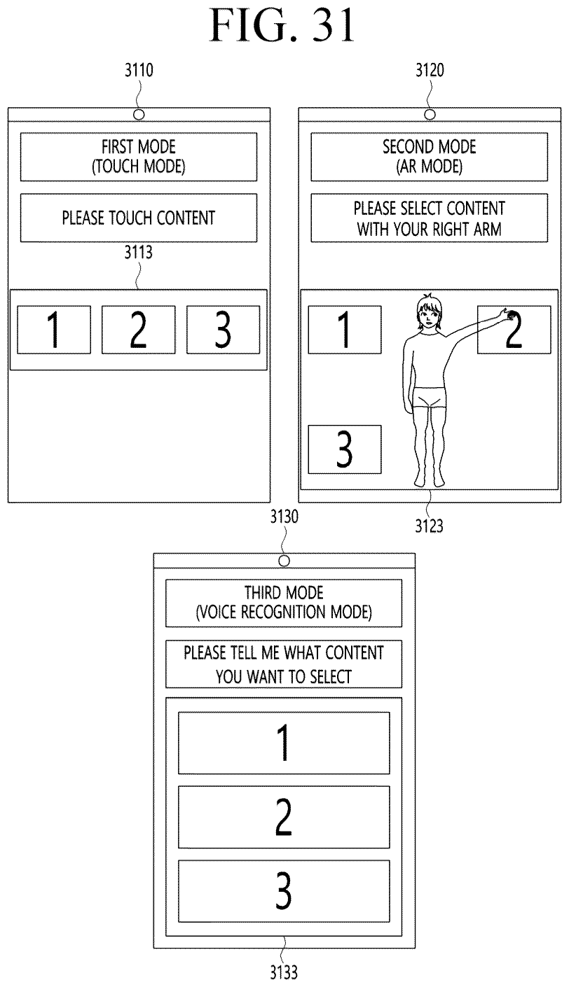

FIG. 31 is a diagram for describing a screen structure displayed based on a mode according to an embodiment.

Referring to FIG. 31, the electronic apparatus 100 may have different screen structures based on the mode being performed.

While performing the first mode, the electronic apparatus 100 may display a screen 3110 including a content list UI 3113 having a first structure.

While performing the second mode, the electronic apparatus 100 may display a screen 3120 including a content list UI 3123 having a second structure.

While performing the third mode, the electronic apparatus 100 may display a screen 3130 including a content list UI 3133 having a third structure.

The first structure, the second structure, and the third structure may be different from one another.

The content list UI may include information related to at least one content. The content information may include at least one of a content name or a content thumbnail image. The structure may include at least one of the position, shape, size, or color of the content list UI. Each structure may be different in at least one of the position, shape, size, or color of the UI.

The size of the content list UI may include an area of a region where the content list UI is displayed.

A first size of the content list UI 3113 in the first mode may be smaller than a second size of the content list UI 3123 in the second mode. The reason is that a region where the user may conveniently touch using a hand is limited during the operation in the touch mode. For example, the user may use a hand in the touch mode although the user may use a hand and a foot in the AR mode.

A second size of the content list UI 3123 in the second mode may be smaller than a third size of the content list UI 3133 in the third mode. The reason is that the region where the user may conveniently input a motion is limited during the operation in the AR mode. The AR mode has a set region for inputting the motion by using a hand and a foot, whereas the voice recognition mode has no limitations on the region for displaying the content list UI.

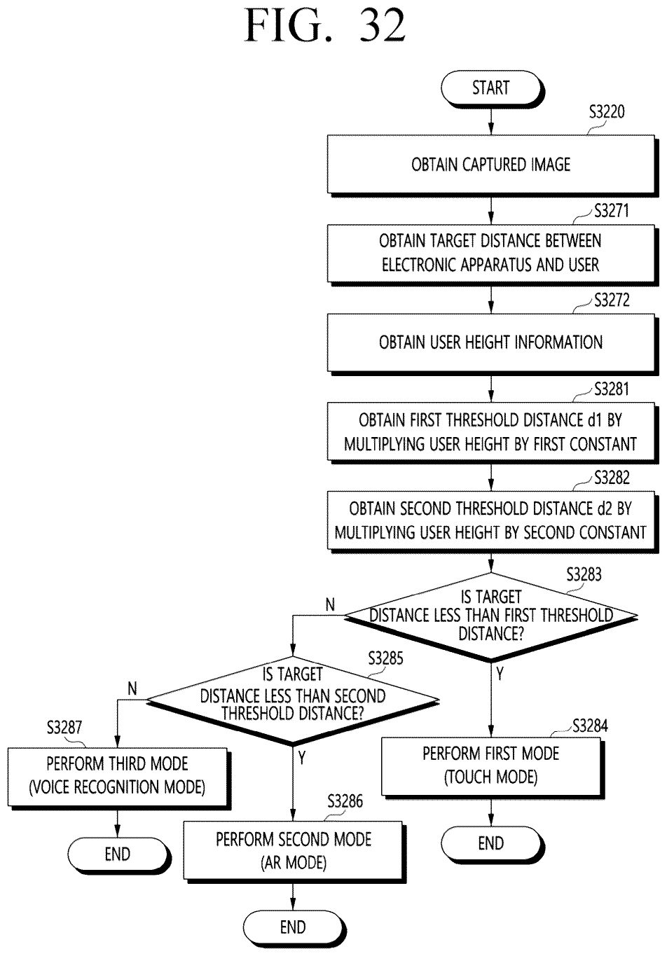

FIG. 32 is a diagram for describing an operation for calculating the threshold distance by using the user height information according to an embodiment.

Referring to FIG. 32, the electronic apparatus 100 may obtain the captured image (S3220). For example, step S3220 may correspond to steps S420 and S460 in FIG. 4.

The electronic apparatus 100 may obtain the target distance between the electronic apparatus 100 and the user (S3271). Step S3271 may correspond to step S1871 in FIG. 18.

The electronic apparatus 100 may obtain the user height information (S3272). Step S3272 may correspond to step S1872 in FIG. 18.

The electronic apparatus 100 may obtain the first threshold distance d1 based on the user height information. The user height information may include the user height value h. The electronic apparatus 100 may obtain the first threshold distance d1 by multiplying the user height value h by the first constant a (S3281). The first constant a may be greater than zero and less than 1.

The electronic apparatus 100 may obtain the second threshold distance d2 based on the user height information. The electronic apparatus 100 may obtain the second threshold distance d2 by multiplying the user height value h by the second constant b (S3282). The second constant b may be the value greater than 1.

The electronic apparatus 100 may identify whether the target distance is less than the first threshold distance d1 (S3283). The electronic apparatus 100 may perform the first mode (S3284) if the target distance is less than the first threshold distance d1 (S3283-Y).

The electronic apparatus 100 may identify whether the target distance is less than or equal to the second threshold distance d2 (S3285) if the target distance is greater than or equal to the first threshold distance d1 (S3283-N). The electronic apparatus 100 may perform the second mode (S3286) if the target distance is less than or equal to the second threshold distance d2 (S3285-Y).

The electronic apparatus 100 may perform the third mode (S3287) if the target distance is greater than or equal to the second threshold distance d2 (S3285-N).

FIG. 33 is a diagram for describing an operation for switching a mode according to an embodiment.

Referring to FIG. 33, the electronic apparatus 100 may perform the first mode or the second mode (S3310).

While the electronic apparatus 100 performs the first mode or the second mode, the electronic apparatus 100 may determine whether the event in which the user holds the cooking utensil using both arms is identified (S3320).

The electronic apparatus 100 may perform the third mode (S3330) if the event in which the user holds the cooking utensil using both arms is identified (S3320-Y). The electronic apparatus 100 may switch the first mode or the second mode to the third mode. If the user holds the cooking utensil using both arms, it may be inconvenient for the user to input the touch or the motion. The electronic apparatus 100 may automatically perform the voice recognition mode to perform the control operation by using the user voice.

For example, the cooking utensil may be replaced with the exercise device. For example, the cooking utensil may be described as a predetermined object.

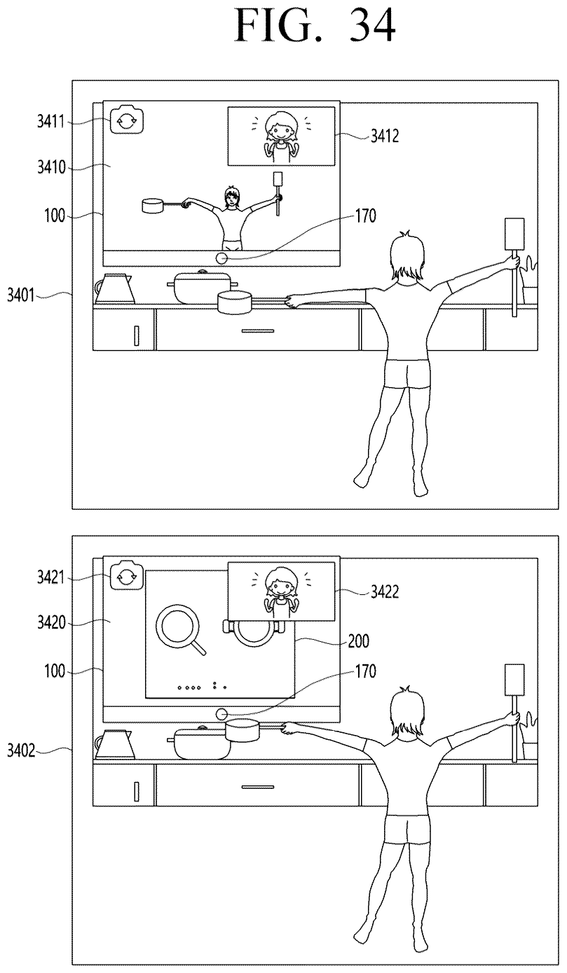

FIG. 34 is a diagram for describing a screen switch operation according to an embodiment.

Referring to FIG. 34, the electronic apparatus 100 may provide a real-time video call function. The user may make a video call with the counterpart. The electronic apparatus 100 may performing capture function by using the camera 170. The electronic apparatus 100 may obtain the captured image. The electronic apparatus 100 may transmit the captured image to the electronic apparatus of a counterpart.

For example, the electronic apparatus 100 may transmit the captured image including the user to the counterpart.

For example, the electronic apparatus 100 may transmit the captured image including a cooking device 200 to the counterpart. The captured image may include food being cooked using the cooking device 200.

The electronic apparatus 100 may obtain the captured image from the camera 170. The electronic apparatus 100 may adjust a capture angle of the camera 170. The electronic apparatus 100 may capture the user at a first angle. The electronic apparatus 100 may capture the cooking device 200 at a second angle.

Referring to Embodiment 3401 of FIG. 34, the electronic apparatus 100 may display a screen 3410 for providing the video call function.

The screen 3410 may include the captured image obtained by the electronic apparatus 100. The captured image may include the user.

The screen 3410 may include a UI 3411 for switching a screen and a UI 3412 for displaying an image related to the counterpart.

The UI 3411 may be a UI for switching the screen transmitted to the counterpart. The electronic apparatus 100 may identify the event in which the user holds the cooking utensil in both hands. The electronic apparatus 100 may perform the third mode (voice recognition mode) if the user identifies the event in which the user holds the cooking utensil in both hands.

The UI 3412 may be a UI for providing content received from the counterpart. The content received from the counterpart may include a captured image obtained from the electronic apparatus of the counterpart.

Referring to Embodiment 3402 of FIG. 34, the electronic apparatus 100 may perform a screen switch operation if the user receives the user voice for instructing execution of the UI 3411. The electronic apparatus 100 may switch the screen 3410 to a screen 3420.

The screen 3420 may include the captured image including the cooking device 200.

The screen 3420 may include a UI 3421 for switching a screen and a UI 3422 for displaying an image related to the counterpart. The UI 3421 may correspond to the UI 3411. The UI 3422 may correspond to the UI 3412.

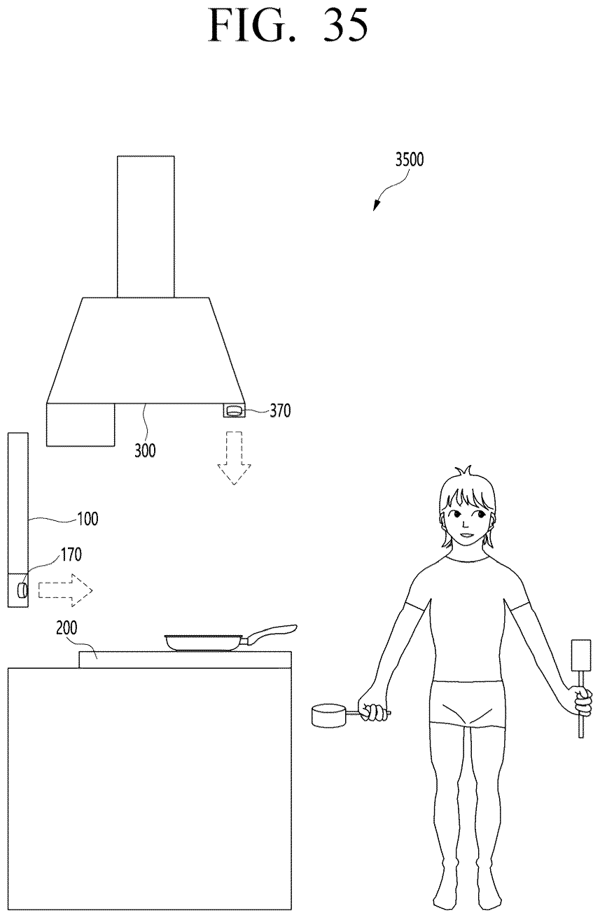

FIG. 35 is a diagram for describing a screen switch operation according to an embodiment.

Referring to Embodiment 3500 of FIG. 35, the electronic apparatus 100 may obtain the captured image of a screen to be switched by using physically separated cameras. Embodiments 3401 and 3402 of FIG. 34 may also be applied to Embodiment 3500 of FIG. 35.

The electronic apparatus 100 may obtain captured data for capturing the user by using the camera 170 included in the electronic apparatus 100. The electronic apparatus 100 may transmit the captured data obtained using the camera 170 to the electronic apparatus of the counterpart.

If the user voice for screen switching is received using the voice recognition, the electronic apparatus 100 may switch a screen to be transmitted to the electronic apparatus of the counterpart. The electronic apparatus 100 may obtain the captured image by using a camera 370 of an external device 300. The captured image may include the cooking device 200. The captured image may include food being cooked by the cooking device 200. The external device 300 may transmit the captured data including the cooking device 200 to the electronic apparatus 100. The electronic apparatus 100 may transmit the captured data to the electronic apparatus of the counterpart.

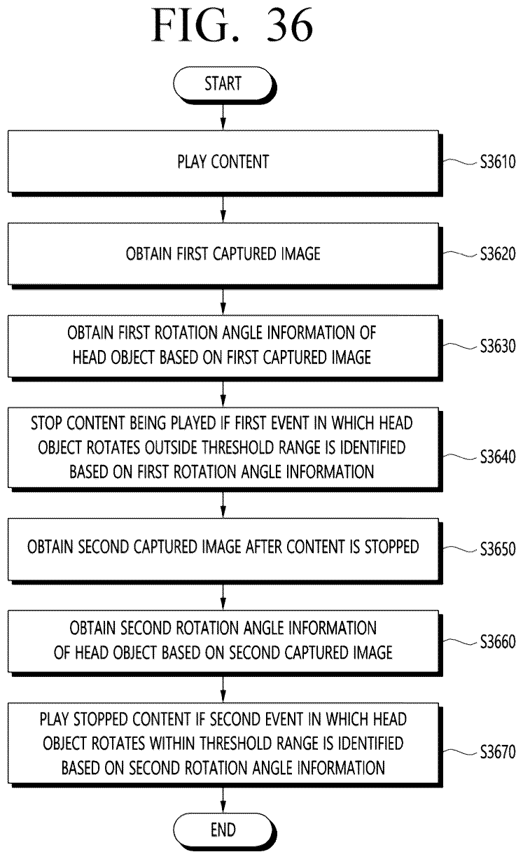

FIG. 36 is a diagram for describing a control method of an electronic apparatus 100 according to an embodiment.

Referring to FIG. 36, the control method of an electronic apparatus may include playing the content stored in the electronic apparatus (S3610), obtaining the first captured image (S3620), obtaining the first rotation angle information of the head object based on the first captured image (S3630), stopping the content being played (S3640) if the first event in which the head object rotates outside the threshold range is identified based on the first rotation angle information, obtaining the second captured image (S3650) after the content is stopped, obtaining the second rotation angle information of the head object based on the second captured image (S3660), and playing the stopped content (S3670) if the second event in which the head object rotates within the threshold range is identified based on the second rotation angle information.

The first rotation angle information may include at least one of the first rotation angle or the first rotation angle change amount, and the second rotation angle information may include at least one of the second rotation angle or the second rotation angle change amount.

The control method may include identifying the head object of the user based on the first captured image, obtaining at least one of the pitch rotation angle or yaw rotation angle of the head object, and obtaining the first rotation angle based on at least one of the pitch rotation angle or the yaw rotation angle.

The control method may include obtaining the first value by multiplying the pitch rotation angle by the first weight, obtaining the second value by multiplying the yaw rotation angle by the second weight, and obtaining the first rotation angle by adding the first value and the second value.

The control method may include obtaining the first rotation angle change amount based on the difference between the rotation angle obtained at the first time point and the rotation angle obtained at the time point previous to the first time point, and obtaining the first rotation angle information including at least one of the first rotation angle or the first rotation angle change amount.

The control method may include identifying the first event if at least one of the first condition, in which the first rotation angle is less than or equal to the first threshold value or greater than or equal to the second threshold value, or the second condition, in which the first rotation angle change amount is less than or equal to the third threshold value or greater than or equal to the fourth threshold value, is satisfied.

The control method may include identifying the second event if the third condition, in which the first rotation angle exceeds the first threshold value and is less than the second threshold value, or the fourth condition, in which the first rotation angle change amount exceeds the third threshold value and is less than the fourth threshold value, is satisfied.

The control method may include generating the guide UI indicating the rotation of the head object based on the first rotation angle, and displaying the guide UI at the predetermined position.

The control method may include identifying the first candidate region corresponding to the hand object of the user and the second candidate region corresponding to the foot object of the user in the first captured image, determining the target position based on the first candidate region and the second candidate region, and displaying the augmented reality UI at the target position to determine whether to play or stop the content.

The control method may include obtaining the target distance between the electronic apparatus and the user, obtaining the user height information, obtaining the first threshold distance based on the user height information, performing the first mode for receiving the touch input if the target distance is less than the first threshold distance, performing the second mode for receiving the motion input if the target distance is greater than or equal to the first threshold distance, and performing the third mode for receiving the voice input if the user is not recognized based on the first captured image.

The methods according to the various embodiments described above may be implemented in the form of an application which may be installed on an existing electronic apparatus.

The methods according to the various embodiments described above may be implemented only by software upgrade or hardware upgrade of the existing display device.

The various embodiments described above may be performed through an embedded server included in the electronic apparatus, or an external server of at least one of the electronic apparatus and the display device.

According to an embodiment, the various embodiments described above may be implemented in software including an instruction stored on a machine-readable storage medium (for example, a computer-readable storage medium). A machine may be a device that invokes the stored instruction from a storage medium, may be operated based on the invoked instruction, and may include the electronic apparatus according to the disclosed embodiments. If the instruction is executed by the processor, the processor may directly perform a function corresponding to the instruction or other components may perform the function corresponding to the instruction under the control of the processor. The instruction may include codes generated or executed by a compiler or an interpreter. The machine-readable storage medium may be provided in the form of a non-transitory storage medium. The term “non-transitory” indicates that the storage medium is tangible without including a signal, and does not distinguish whether data are semi-permanently or temporarily stored on the storage medium.

For example, a non-transitory computer-readable recording medium having instructions recorded thereon, that, when executed by at least one processor, individually or collectively, may cause the at least one processor to play content stored in memory and display the content being played; obtain a first captured image from a camera; obtain first rotation angle information of a head object based on the first captured image; stop the content being played based on the first rotation angle information indicating a first event in which the head object rotates outside a threshold range; obtain a second captured image from the camera after the content is stopped; obtain second rotation angle information of the head object based on the second captured image; and play the content that is stopped based on the second rotation angle information indicating a second event in which the head object rotates within the threshold range is identified based on the second rotation angle information.

According to an embodiment of the present disclosure, the methods according to the various embodiments described above may be included and provided in a computer program product. The computer program product may be traded as a commodity between a seller and a purchaser. The computer program product may be distributed in a form of the machine-readable storage medium (for example, a compact disc read only memory (CD-ROM)), or may be distributed online through an application store. In case of the online distribution, at least a portion of the computer program product may be at least temporarily stored or temporarily generated on a storage medium such as the memory of a manufacturer server, an application store server, or a relay server.

Each of the components (for example, modules or programs) according to the various embodiments described above may include a single entity or a plurality of entities, and other sub-components may be further included in the various embodiments. Some of the components (for example, the modules or the programs) may be integrated into the single entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order, or other operations may be added.

Although the embodiments are shown and described in the present disclosure as above, the present disclosure is not limited to the above-described embodiments and may be variously modified by those skilled in the art to which the present disclosure pertains without departing from the scope of the present disclosure as claimed in the accompanying claims. These modifications should also be understood to fall within the scope of the present disclosure.

What is claimed is:

1. An electronic apparatus comprising:
memory storing instructions;
a display;
a camera; and
at least one processor,
wherein the instructions, when executed, individually or collectively, by the at least one processor, cause the electronic apparatus to:
play content stored in the memory and display the content being played on the display;
obtain a first captured image from the camera;
obtain first rotation angle information of a head object based on the first captured image;
stop the content being played based on the first rotation angle information indicating a first event in which the head object rotates outside a threshold range;
obtain a second captured image from the camera after the content is stopped;
obtain second rotation angle information of the head object based on the second captured image; and
play the content that is stopped based on the second rotation angle information indicating a second event in which the head object rotates within the threshold range.

2. The electronic apparatus as claimed in claim 1, wherein the first rotation angle information comprises at least one of a first rotation angle or a first rotation angle change amount, and
wherein the second rotation angle information comprises at least one of a second rotation angle or a second rotation angle change amount.

3. The electronic apparatus as claimed in claim 2, wherein the instructions, when executed, individually or collectively, by the at least one processor, cause the electronic apparatus to:
identify the head object of a user based on the first captured image;
obtain at least one of a pitch rotation angle or a yaw rotation angle of the head object; and
obtain the first rotation angle based on the at least one of the pitch rotation angle or the yaw rotation angle.

4. The electronic apparatus as claimed in claim 3, wherein the instructions, when executed, individually or collectively, by the at least one processor, cause the electronic apparatus to:
obtain a first value by multiplying the pitch rotation angle by a first weight;
obtain a second value by multiplying the yaw rotation angle by a second weight; and
obtain the first rotation angle by adding the first value to the second value.

5. The electronic apparatus as claimed in claim 4, wherein the first rotation angle change amount is obtained based on a difference between a rotation angle obtained at a first time point and a rotation angle obtained at a time point previous to the first time point.

6. The electronic apparatus as claimed in claim 5, wherein the instructions, when executed, individually or collectively, by the at least one processor, cause the electronic apparatus to identify the first event based on at least one of a first condition or a second condition being satisfied,
wherein the first condition is satisfied based on the first rotation angle being less than or equal to a first threshold value or the first rotation angle being greater than or equal to a second threshold value, and
wherein the second condition is satisfied based on the first rotation angle change amount being less than or equal to a third threshold value or the first rotation angle change amount being greater than or equal to a fourth threshold value.

7. The electronic apparatus as claimed in claim 6, wherein the instructions, when executed, individually or collectively, by the at least one processor, cause the electronic apparatus to identify the second event based on at least one of a third condition or a fourth condition being satisfied,
wherein the third condition is satisfied based on the first rotation angle exceeding the first threshold value and the first rotation angle being less than the second threshold value, and
wherein the fourth condition is satisfied based on the first rotation angle change amount exceeding the third threshold value and the first rotation angle change amount being less than the fourth threshold value.

8. The electronic apparatus as claimed in claim 4, wherein the instructions, when executed, individually or collectively, by the at least one processor, cause the electronic apparatus to:
generate a guide user interface (UI) indicating a rotation of the head object based on the first rotation angle; and
control the display to display the guide UI at a predetermined position.

9. The electronic apparatus as claimed in claim 1, wherein the instructions, when executed, individually or collectively, by the at least one processor, cause the electronic apparatus to:
identify a first candidate region corresponding to a hand object of a user and a second candidate region corresponding to a foot object of the user in the first captured image;
determine a target position based on the first candidate region and the second candidate region; and
control the display to display an augmented reality UI at the target position to determine whether to play or stop the content.

10. The electronic apparatus as claimed in claim 1, wherein the instructions, when executed, individually or collectively, by the at least one processor, cause the electronic apparatus to:
obtain a target distance between the electronic apparatus and a user;
obtain user height information;
obtain a first threshold distance based on the user height information;
perform a first mode for receiving a touch input based on the target distance being less than the first threshold distance;
perform a second mode for receiving a motion input based on the target distance being greater than or equal to the first threshold distance; and
perform a third mode for receiving a voice input if the user is not recognized based on the first captured image.

11. A control method of an electronic apparatus comprising:
playing content stored in memory and displaying the content being played;
obtaining a first captured image from a camera;
obtaining first rotation angle information of a head object based on the first captured image;
stopping the content being played based on the first rotation angle information indicating a first event in which the head object rotates outside a threshold range;
obtaining a second captured image from the camera after the content is stopped;
obtaining second rotation angle information of the head object based on the second captured image; and
playing the content that is stopped based on the second rotation angle information indicating a second event in which the head object rotates within the threshold range.

12. The method as claimed in claim 11, wherein the first rotation angle information comprises at least one of a first rotation angle or a first rotation angle change amount, and
wherein the second rotation angle information comprises at least one of a second rotation angle or a second rotation angle change amount.

13. The method as claimed in claim 12, wherein the obtaining the first rotation angle information comprises:
identifying the head object of a user based on the first captured image;
obtaining at least one of a pitch rotation angle or a yaw rotation angle of the head object; and
obtaining the first rotation angle based on the at least one of the pitch rotation angle or the yaw rotation angle.

14. The method as claimed in claim 13, wherein the obtaining the first rotation angle information comprises:
obtaining a first value by multiplying the pitch rotation angle by a first weight;
obtaining a second value by multiplying the yaw rotation angle by a second weight; and
obtaining the first rotation angle by adding the first value to the second value.

15. The method as claimed in claim 14, wherein the first rotation angle change amount is obtained based on a difference between a rotation angle obtained at a first time point and a rotation angle obtained at a time point previous to the first time point.

16. The method as claimed in claim 15, wherein the first event is identified based on at least one of a first condition or a second condition being satisfied,
wherein the first condition is satisfied based on the first rotation angle being less than or equal to a first threshold value or the first rotation angle being greater than or equal to a second threshold value, and
wherein the second condition is satisfied based on the first rotation angle change amount being less than or equal to a third threshold value or the first rotation angle change amount being greater than or equal to a fourth threshold value.

17. The method as claimed in claim 16, wherein the second event is identified based on at least one of a third condition or a fourth condition being satisfied,
wherein the third condition is satisfied based on the first rotation angle exceeding the first threshold value and the first rotation angle being less than the second threshold value, and
wherein the fourth condition is satisfied based on the first rotation angle change amount exceeding the third threshold value and the first rotation angle change amount being less than the fourth threshold value.

18. The method as claimed in claim 14, further comprising:
generating a guide user interface (UI) indicating a rotation of the head object based on the first rotation angle; and
displaying the guide UI at a predetermined position.

19. The method as claimed in claim 11, further comprising:
identifying a first candidate region corresponding to a hand object of a user and a second candidate region corresponding to a foot object of the user in the first captured image;
determining a target position based on the first candidate region and the second candidate region; and
displaying an augmented reality UI at the target position to determine whether to play or stop the content.

20. A non-transitory computer-readable recording medium having instructions recorded thereon, that, when executed by at least one processor, individually or collectively, cause the at least one processor to:
play content stored in memory and display the content being played;
obtain a first captured image from a camera;
obtain first rotation angle information of a head object based on the first captured image;
stop the content being played based on the first rotation angle information indicating a first event in which the head object rotates outside a threshold range;
obtain a second captured image from the camera after the content is stopped;
obtain second rotation angle information of the head object based on the second captured image; and
play the content that is stopped based on the second rotation angle information indicating a second event in which the head object rotates within the threshold range is identified based on the second rotation angle information.
